(19) United States
(12) Patent Application Publication
(10) Pub. No.: US 2026/0059045 A1
(43) Pub. Date: Feb. 26, 2026

(54) SYSTEMS AND METHODS FOR ESTABLISHING MUTUAL PARTY IDENTITY TRUST FOR CALL REQUEST HANDLING

(71) Applicant: Wells Fargo Bank, N.A., San Francisco, CA (US)

(72) Inventors: Ashmita Regmi, Atlanta, GA (US); Ian T. Staley, Seattle, WA (US); Anita Sukur, Minneapolis, MN (US)

(21) Appl. No.: 18/815,515

(22) Filed: Aug. 26, 2024

(51) Int. Cl. H04M 3/22; H04M 3/42; H04M 3/523

(52) U.S. Cl. CPC H04M 3/2281; H04M 3/42059; H04M 3/5235

(57) ABSTRACT

Systems, apparatuses, methods, and computer program products are disclosed for handling a call request. An example method includes receiving a logon request for a user account from a user device and performing an authentication routine to determine whether to authenticate the logon request. In an instance in which the logon request is successfully authenticated, the example method further includes establishing a secure session with the user device and receiving the call request from the user device. The example method further includes determining a verified internal phone number based on the call request and providing the verified internal phone number to the user device. The example method further includes updating a decentralized identifier (DID) document associated with a user DID to reflect the call request.

### BACKGROUND

Customers of an institution may wish to call an agent of the institution for a variety of reasons. Oftentimes, these calls involve a one-way authentication where agents request sensitive information from the customer to verify his/her identity. However, customers currently lack the ability to determine whether they are speaking with a verified and trusted agent of the institution.

### BRIEF SUMMARY

Traditionally, customers may need to provide sensitive or private information (e.g., birth date, a social security number (SSN), residential information, or the like) to an institution agent over a phone call in order to verify his/her identity. In conventional systems, the user is not provided with a mechanism to verify that the party with whom he/she speaks is a verified agent of the institution and, thus, the user is potentially susceptible to an imposter scam by a would-be fraudster.

Some institutions have instituted two-factor authentication (2FA) or multifactor authentication (MFA) setups. However, sole reliance on 2FA and/or MFA systems still leaves users vulnerable to man-in-the-middle attacks. Additionally, these traditional approaches have been one-sided and merely serve to authenticate the customer, but do not give the customer confidence in the authenticity of the agent representative. Thus, even these approaches leave customers vulnerable to fraudulent activity, such as phishing scams or impersonation scams. For example, a user who mistakenly believes a fraudster's number to be legitimately associated with his/her bank may reveal sensitive information that the fraudster can then use to access the customer's accounts. Even if the provision of the sensitive information is to a legitimate agent, because these conventional approaches only establish one-way trust, the customer is not provided with any knowledge of the agent's identity. Thus, customers may actually be more susceptible to fraudulent using these 2FA or MFA approaches that purport to enhance security.

In contrast to these conventional techniques for caller authentication, example embodiments described herein allow for shared trust to be established between a user and an agent during a phone call between the parties. In doing so, example embodiments described herein establish mutual trust between the parties, while providing seamless authentication experience to the user.

In particular, a user may pre-stage an incoming phone call with an institution agent. This may require the user to log into his/her user account via a software application on his/her device. The identity authentication management system may then perform an authentication routine to determine whether the logon request can be successfully authenticated. If a logon request is successfully authenticated, the identity authentication management system may establish a secure session with the user device. The user may then use the software application operating on the user device to provide a call request to identity authentication management system. The call request may be indicative of a request to be connected with a verified agent. As such, the call request may only be received from a user device with an established, secure session. This provides an enhanced layer of security as it requires the user to be authenticated prior to providing any call request.

Upon receipt of the call request, the identity authentication management system may update a decentralized identifier (DID) document associated with a user DID. The user DID may be stored on distributed ledger or blockchain (e.g., DID storage repository) along with a hash of the DID document, which may be stored in a separate storage location (e.g., a communications storage repository). As such, in order for a DID document to be successfully updated, the identity authentication management system may be required to digitally sign the updated DID document using a private cryptographic key associated with the DID document, which may then be verified by nodes on the blockchain and only in an instance in which the digital signature is found to be valid, is the user DID updated to reference the updated DID document. As such, the DID document associated with the globally unique user DID may only be updated to reflect the call request by a legitimate device (e.g., identity authentication management system).

Additionally, responsive to receipt of the call request during the secure session, the identity authentication management system may determine a verified phone number to provide the user device and that the user may use for the requested call. The verified internal phone number may a trusted, verified phone number that may be used by a user device to securely connect the user and an agent. In some embodiments, a verified internal phone number may correspond to a department, team, group, or individual. The identity authentication management system may determine the particular verified internal phone number to provide a user based on call context information. In particular, in some embodiments, the identity authentication management system may process the call context information to determine a call request reason and use a call routing protocol to determine a verified internal phone number. The call routing protocol may further consider call request metadata in view to determine a verified internal phone number. As such, the identity authentication management system may determine a verified internal phone number that may be suited to handle the inferred needs of the user and thereby provides for an enhanced user experience.

Once the verified internal phone number has been provided to the user device, the user device may perform a call over any suitable communication channel (e.g., over a public switched telephone network (PSTN), a cellular network, a voice over internet protocol (VOIP) network, or the like) using the provided verified internal phone number. The identity authentication management system may receive a notification of the incoming call and in turn, may cause identify a user account associate with the call. The identity authentication management system may use a device identifier (e.g., a phone number) associated with the user device performing the call and/or may use one or more additional user identifiers if available to identify a user account associated with the one or more user identifiers. The identity authentication management system may then use the user DID from the user account to access an associated DID document and determine whether the DID document is indicative of the call request. If the DID document is indicative of the call request, this may demonstrate that the incoming call from the user device has been pre-staged and that the user and/or user device have been authenticated via the previously performed authentication routine. As such, the identity authentication management system may determine the user and/or user device may be trusted during the incoming call and thus, the user may not be required to perform additional authentication procedures as required during conventional incoming calls, thereby reducing user friction and improving the overall user experience.

Once the user and/or user device have been authenticated based on the DID document, the identity authentication management system may select an agent to handle the call with the user. In particular, the identity authentication management system may select an agent that is currently associated with an authenticated session and may thereby ensure that the agent with whom the user is to be connected has also been authenticated and can be trusted. Additionally, the identity authentication management system may further select an agent that is associated with the verified internal phone number. Said otherwise, the identity authentication management system may select an agent from a department, group, team, etc. that corresponds to the verified internal phone number. As such, the selected agent may be capable of handling the user requests and reason for calling as determined earlier by the identity authentication management system.

In some embodiments, in an instance in which the phone number of the user device is solely used to identify the user account, the identity authentication management system may still identify the user account but may flag the incoming call as requiring additional authentication operations. The additional authentication protocols may be used to confirm the identity of the user and to ensure that the user device is not a spoofed device. In some embodiments, prior to causing the call to be connected with an agent, the identity authentication management system may perform an authentication protocol that may require the user to audibly respond or manually input (e.g., via a dial pad) a user response to one or more questions. The identity authentication management system may then compare the user provided responses to the values stored in the user account to determine whether to authenticate the user. Additionally, or alternatively, the identity authentication management system may cause the user device to be connected to an agent device and then perform an authentication protocol. In some embodiments, the identity authentication management system may perform an authentication protocol that requires the agent asks the user one or more questions that the agent then compares to the stored user values in the user profile. The identity authentication management system may then determine whether the user is successfully authenticated based on agent feedback or an agent response. In some embodiments, the identity authentication management system may perform an authentication protocol that requires the provision of a one-time passcode (OTP) to the user device or agent device. In some embodiments, the parties may be required to exchange the OTP. Additionally, or alternatively, the user may be required to enter the OTP into a software application with an active session or the agent to enter the OTP into a secure account environment. As such, these additional authentication protocols may ensure the identity of the user such that bidirectional trust may be established between the parties. Additionally, even in an instance in which these additional authentication protocols are performed, the user may still be connected with an agent without navigating through a conventional call routing system.

Once the user device and agent device have been connected, each party may be provided with an indication that the other party's identity has been authenticated and can be trusted. As such, this may allow the parties to establish bidirectional trust in one another. In particular, in some embodiments, the agent may directly proceed with facilitating user requests made by the user without performing additional authentication protocols, unless otherwise directed. Additionally, the user may be provided reassurance that he/she is speaking with an authorized agent. In some embodiments, the user may further be provided with agent information, which may provide additional confidence in the agent identity. In some embodiments, the call may be recorded in a call history record. In some embodiments, updating the call history record may include generating and updating a call history database, a DID document associated with a user DID, and/or a DID document associated with an agent DID to reflect the call. As such, a record of the call may be stored and can be used to quality assurance, as an audit trail, and/or the like.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to establish a mutual party identity trust between a user and an agent for an incoming phone call.

FIG. 2 illustrates a schematic block diagram of example circuitry embodying a system device that may perform various operations in accordance with some example embodiments described herein.

FIG. 3 illustrates a schematic block diagram of example circuitry embodying a user device and/or an agent device that may perform various operations in accordance with some example embodiments described herein.

FIG. 4 illustrates an example flowchart for handling a call request from a user device, in accordance with some example embodiments described herein.

FIG. 5 illustrates an example flowchart for performing an authentication process using a passkey, in accordance with some example embodiments described herein.

FIG. 6 illustrates an example flowchart for establishing a secure session with an agent device, in accordance with some example embodiments described herein.

FIG. 7 illustrates an example flowchart for handling an incoming call from a user device, in accordance with some example embodiments described herein.

FIG. 8 illustrates an example flowchart for generating a DID and DID document, in accordance with some example embodiments described herein.

FIG. 9 illustrates an example flowchart for establishing a secure session as performed by a user device or an agent device, in accordance with some example embodiments described herein.

FIG. 10 illustrates an example flowchart for performing a call operation as performed by a user device, in accordance with some example embodiments described herein.

FIGS. 11A, 11B, and 11C illustrate swim lane diagrams with example operations that may be performed by components of the environment depicted in FIG. 1, in accordance with some example embodiments described herein.

FIGS. 12A and 12B illustrate example user interfaces used to generate a call request, in accordance with some example embodiments described herein.

FIG. 13 illustrates an example user interface with agent information for a current call, in accordance some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

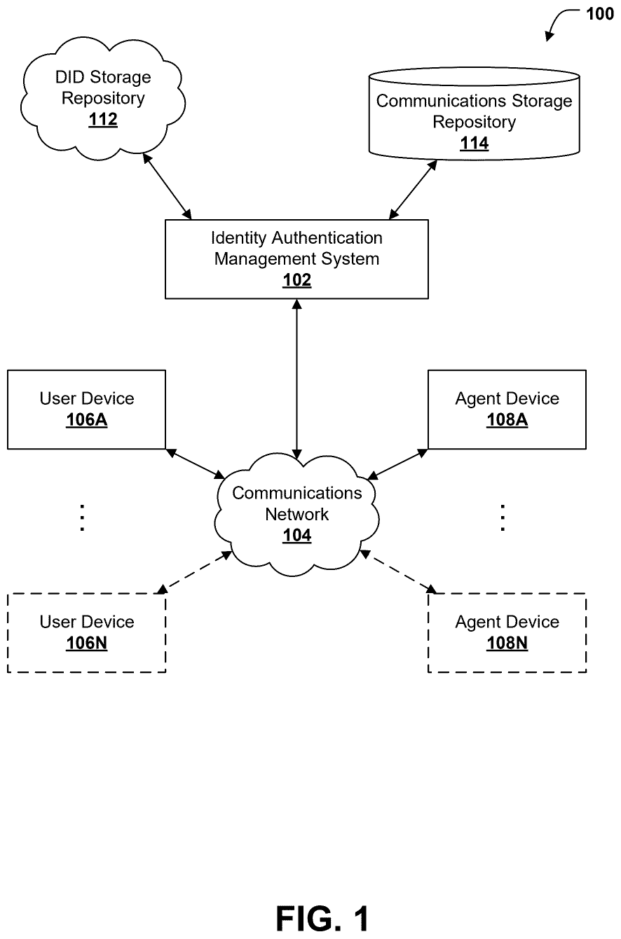

Example embodiments described herein may be implemented using any of a variety of computing devices or servers. To this end, FIG. 1 illustrates an example environment 100 within which various embodiments may operate. As illustrated, an identity authentication management system 102 may receive and/or transmit information via communications network 104 (e.g., the Internet) with any number of other devices, such as one or more of user devices 106A-106N and/or agent devices 108A-108N. In some embodiments, the identity authentication management system 102 may receive and/or transmit information via a private or restricted communication environment within which only certain, authorized devices may communication. For example, in some embodiments, identity authentication management system 102 and one or more agent devices 108A-108N may be authorized devices and may receive and/or transmit information via a trusted communications network (e.g., intranet).

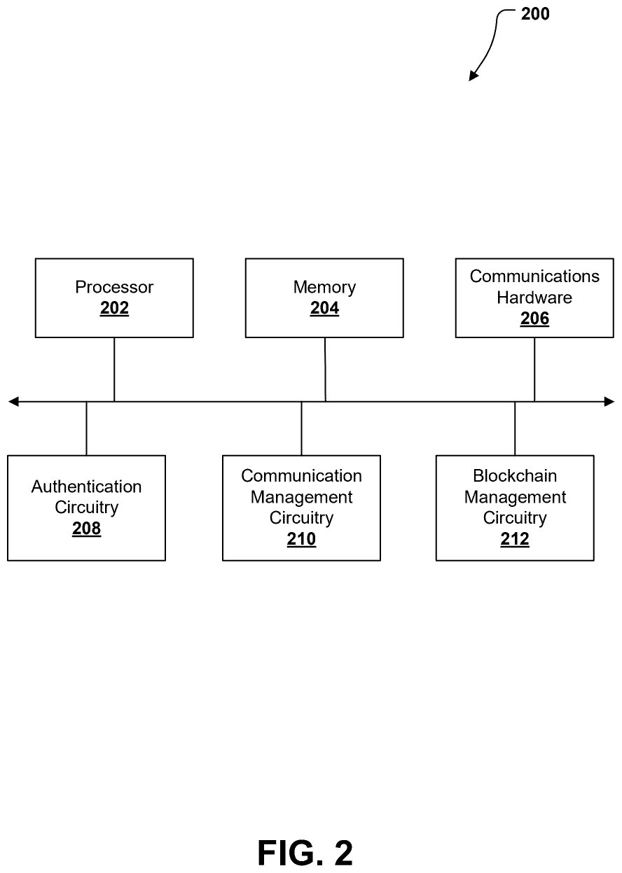

The identity authentication management system 102 may be implemented as one or more computing devices or servers, which may be composed of a series of components. Particular components of the identity authentication management system 102 are described in greater detail below with reference to apparatus 200 in connection with FIG. 2.

The one or more user devices 106A-106N and/or the one or more agent devices 108A-108N may be embodied by any computing devices known in the art. The one or more user devices 106A-106N and/or the one or more agent devices 108A-108N need not themselves be independent devices but may be peripheral devices communicatively coupled to other computing devices. In some embodiments, a user device (e.g., any one of user devices 106A-106N) may be associated with a user who has a user account maintained by the identity authentication management system 102 (e.g., a customer). In some embodiments, an agent device (e.g., any one of agent devices 108A-108N) may be associated with an agent who is an authorized user associated with the identity authentication management system 102 (e.g., an employee of the entity associated with the identity authentication management system 102).

Although FIG. 1 illustrates an environment and implementation in which the identity authentication management system 102 interacts indirectly with a user via one or more of user devices 106A-106N and/or agent devices 108A-108N, in some embodiments users may directly interact with the identity authentication management system 102 (e.g., via communications hardware of the identity authentication management system 102), in which case a separate user device 106A-106N and/or agent device 108A-108N may not be utilized. Whether by way of direct interaction or indirect interaction via another device, a user may communicate with, operate, control, modify, or otherwise interact with the identity authentication management system 102 to perform the various functions and achieve the various benefits described herein.

In some embodiments, the identity authentication management system 102 further includes DID storage repository 112. In some embodiments, the DID storage repository 112 is a distributed ledger, such as a blockchain. In some embodiments, the DID storage repository 112 may be embodied as a server or collection of servers that may interface with decentralized applications such as a distributed ledger to track or enable certain functionality. In some embodiments, the collection of networked distributed ledger nodes of a blockchain, which may be permissionless (public) or permissioned (private). For example, in some embodiments, the DID storage repository 112 may comprise a collection of networked distributed ledger nodes of a blockchain or blockchain technology that is capable of creating and exchanging blockchain tokens. In some embodiments, the distributed ledger may allow for Turing-complete scripting of contracts, known also as smart contracts, distributed applications, or decentralized applications, to be executed on the distributed ledger or blockchain. The distributed ledger may be related to other blockchain networks not pictured here. For example, the distributed ledger may be a sidechain of another blockchain network, or another network (not shown) may form a sidechain of the distributed ledger. The nodes may be embodied by specialized node devices, or may be embodied by any computing devices or server devices known in the art. In some embodiments the identity authentication management system 102 may be a node of the distributed ledger or may be external to the blockchain. In some embodiments, the blockchain is a federated blockchain that is associated with one or more third-party entities. In some embodiments, user DIDs and agent DIDs may be stored within a block on the blockchain of the DID storage repository 112.

In some embodiments, the identity authentication management system 102 further includes communications storage repository 114 that may comprise a distinct component from other components of the identity authentication management system 102. The communications storage repository 114 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). In some embodiments, communications storage repository 114 may host the software executed to operate the identity authentication management system 102. In some embodiments, the communications storage repository 114 may be hosted on the cloud by a cloud service. In some embodiments, the communications storage repository may be a secure, distributed file system. For example, the communications storage repository 114 may be an interplanetary file system (IPFS). Alternatively, the communications storage repository 114 may be a blockchain or a distributed database. The communications storage repository 114 may store information relied upon during operation of the identity authentication management system 102, such as various DID documents that correspond to a user DID or agent DID.

### Example Implementing Apparatuses

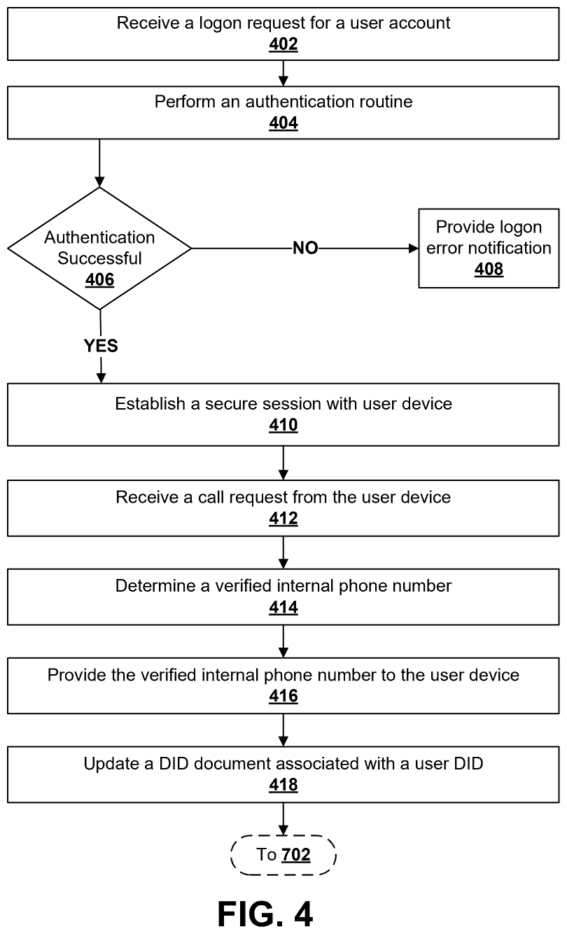

The identity authentication management system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 4-8. As illustrated in FIG. 2, the apparatus 200 may include processor 202, memory 204, communications hardware 206, authentication circuitry 208, communication management circuitry 210, and blockchain management circuitry 212, each of which will be described in greater detail below.

The processor 202 (and/or co-processor or any other processor assisting or otherwise associated with the processor) may be in communication with the memory 204 via a bus for passing information amongst components of the apparatus 200. The processor 202 may be embodied in a number of different ways and may, for example, include one or more processing devices configured to perform independently. Furthermore, the processor 202 may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor 202. In some cases, the processor 202 may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, software application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises authentication circuitry 208 that may be configured to perform an authentication routine to authenticate logon requests. In some embodiments, the authentication circuitry 208 may further be configured to generate a challenge, provide a challenge to a device, receive a challenge response, and/or verify a digitally signed challenge. The authentication circuitry 208 may utilize processor 202, memory 204, or any other hardware component included in the apparatus 200 to perform these operations, as described in connection with FIGS. 4-8 below. The authentication circuitry 208 may further utilize communications hardware 206 to gather data from a variety of sources (e.g., any one of user devices 106A-106N, agent devices 108A-108N, DID storage repository 112, or communications storage repository 114, as shown in FIG. 1), and/or exchange data with a user and/or agent.

In addition, the apparatus 200 further comprises communication management circuitry 210 that may be configured to determine a verified internal phone number, update a DID document associated with a user DID, determine a user account associated with a device identifier, determine whether a DID document reflects a call request, select an agent, establish a connection between a user device and an agent device, determine and provide agent information, and/or the like. The communication management circuitry 210 may utilize processor 202, memory 204, or any other hardware component included in the apparatus 200 to perform these operations, as described in connection with FIGS. 4-8 below. The communication management circuitry 210 may further utilize communications hardware 206 to gather data from a variety of sources (e.g., any one of user devices 106A-106N, agent devices 108A-108N, DID storage repository 112, or communications storage repository 114, as shown in FIG. 1), and/or exchange data with a user.

Further, the apparatus 200 further comprises a blockchain management circuitry 212 that may be configured to generate a user DID and/or agent DID, generate DID documents for a DID, provide the user DID or agent DID to a DID storage repository 112, update a DID document, and/or the like. The blockchain management circuitry 212 may utilize processor 202, memory 204, or any other hardware component included in the apparatus 200 to perform these operations, as described in connection with FIGS. 4-8 below. The blockchain management circuitry 212 may further utilize communications hardware 206 to gather data from a variety of sources (e.g., any one of user devices 106A-106N, agent devices 108A-108N, DID storage repository 112, or communications storage repository 114, as shown in FIG. 1), and/or exchange data with a user.

Although components 202-212 are described in part using functional language, it will be understood that the particular implementations necessarily include the use of particular hardware. It should also be understood that certain of these components 202-212 may include similar or common hardware. For example, the authentication circuitry 208, communication management circuitry 210, and blockchain management circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the authentication circuitry 208, communication management circuitry 210, and blockchain management circuitry 212 may leverage processor 202, memory 204, or communications hardware 206 as described above, it will be understood that any of authentication circuitry 208, communication management circuitry 210, and blockchain management circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that authentication circuitry 208, communication management circuitry 210, and blockchain management circuitry 212 comprise particular machinery designed for performing the functions described herein in connection with such elements of apparatus 200.

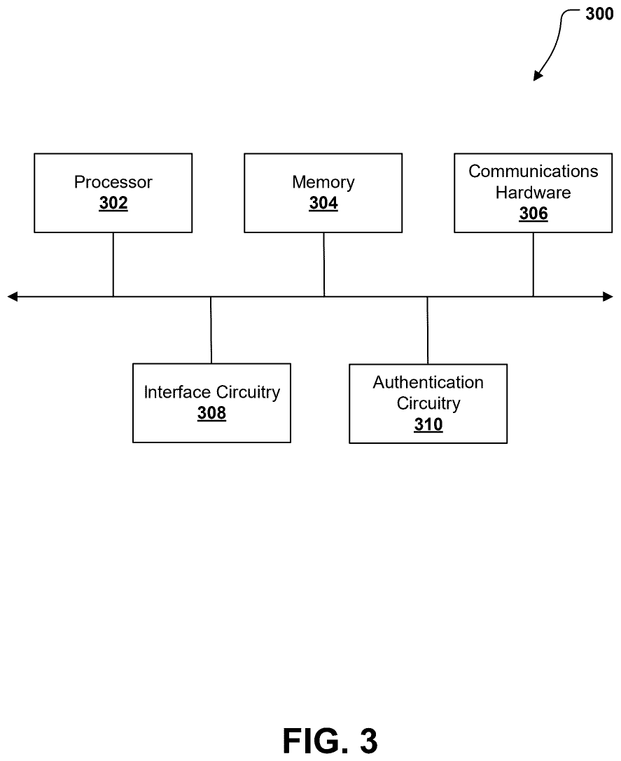

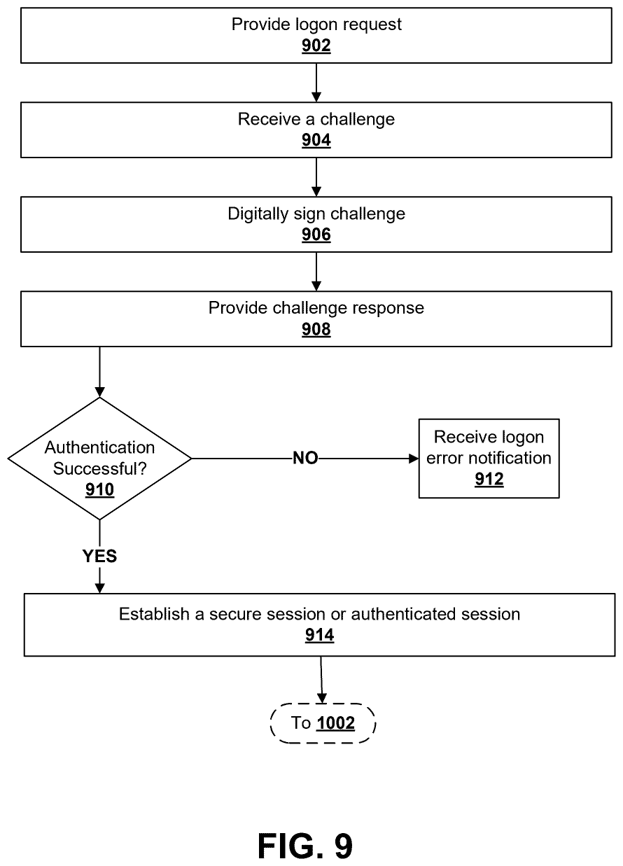

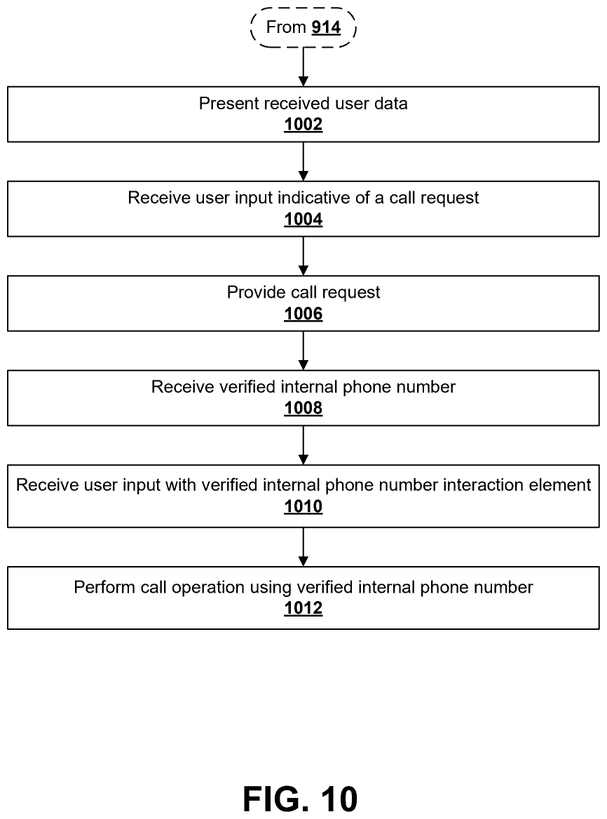

As illustrated in FIG. 3, an apparatus 300 is shown that represents an example user device (e.g., any of user devices 106A-106N) or an example agent device (e.g., any of agent devices 108A-108N). The apparatus 300 includes processor 302, memory 304, and communications hardware 306, and may optionally include interface circuitry 308 and authentication circuitry 310. The interface circuitry 308 may utilize processor 302, memory 304, or any other hardware component included in the apparatus 300 to perform operations, as described in connection with FIG. 9-10 below.

In some embodiments, the interface circuitry 308 includes hardware components configured for receiving user inputs and/or rendering virtual graphics outputs. The interface circuitry 308 may utilize processor 302, memory 304, or any other hardware component included in, or integrated with, the apparatus 300 to perform these operations, as described in connection with FIGS. 9-10 below. The interface circuitry 308 may further utilize communications hardware 306 to transmit data representative of a user input and/or receive data to render as a virtual graphics output or may otherwise utilize processor 302 and/or memory 304 to generate data representative of a user input and/or generate virtual graphics output, e.g., from based on received data. The interface circuitry 308 may comprise one or more of a keyboard, pointing device, touchscreen, microphone with speech recognition interface, one or more cameras, and/or one or more other input devices capable of receiving various different user inputs. In addition, the interface circuitry 308 may comprise a display device including one or more of a screen with graphical user interface (GUI), speaker, light-emitting diode (LED) display, organic LED (OLED) display, LCD display, touchscreen, haptic technology device, and/or other output device capable of rendering information to a user.

In some embodiments, the authentication circuitry 310 includes hardware components configured for managing cryptographic keys stored by the apparatus 300. In some embodiments, the authentication circuitry 310 may be configured to digitally sign authentication challenges received from other devices using a stored private cryptographic key of a passkey. The authentication circuitry 310 may further encrypt or otherwise protect the private cryptographic key for corresponding passkeys.

In some embodiments, various components of the apparatuses 200 and 300 may be hosted remotely (e.g., by one or more cloud servers) and thus need not physically reside on the corresponding apparatus 200 or 300. For instance, some components of the apparatus 200 may not be physically proximate to the other components of apparatus 200. Similarly, some or all of the functionality described herein may be provided by third-party circuitry. For example, a given apparatus 200 may access one or more third-party circuitries in place of local circuitries for performing certain functions.

As will be appreciated based on this disclosure, example embodiments contemplated herein may be implemented by an apparatus 200 or 300. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2 or apparatus 300 as described in FIG. 3, that loading the software instructions onto a computing device or apparatus produces a special-purpose machine comprising the means for implementing various functions described herein.

Having described specific components of example apparatuses 200 and 300, example embodiments are described below in connection with a series of graphical user interfaces and flowcharts.

### Example Identity Authentication Management System Operations

Turning to FIGS. 4-8, example flowcharts are illustrated that contain example operations implemented by example embodiments described herein. The operations illustrated in FIGS. 4-8 may, for example, be performed by system device of identity authentication management system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, authentication circuitry 208, communication management circuitry 210, blockchain management circuitry 212 and/or any combination thereof. It will be understood that user interaction with the identity authentication management system 102 may occur directly via communications hardware 206 or may instead be facilitated by a separate user device (e.g., any one of user devices 106A-106N) and/or a separate agent device (e.g., any one of agent devices 108A-108N), as shown in FIG. 1, and which may have similar or equivalent physical componentry facilitating such user interaction.

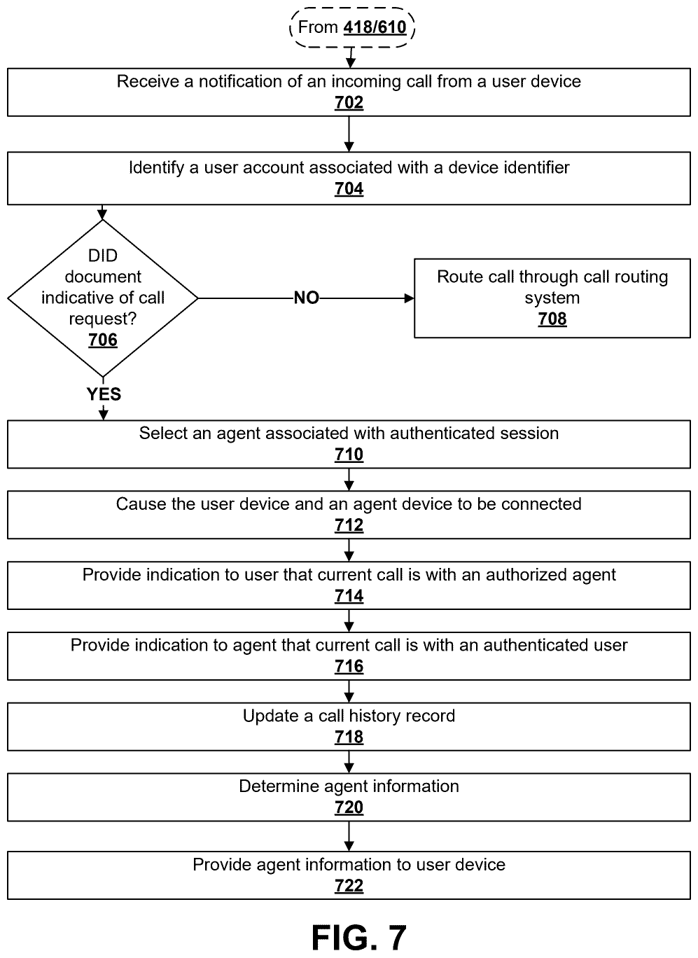

Turning first to FIG. 4, example operations are shown for handling a call request. As shown in FIG. 4, apparatus 200 may authenticate a logon request received from a user and in an instance in which the logon request is successfully authenticated, apparatus 200 may establish a secure session with a corresponding user device. Once a secure session is established with the user device, apparatus 200 may receive a call request from the user device and in response, apparatus 200 may determine a verified internal phone number to facilitate the call request and provide this verified internal phone number to the user device. Apparatus 200 may further update a DID document associated with a user DID to reflect the call request. In this way, apparatus 200 may authenticate the user prior to receiving a call request from the user device. As such, apparatus 200 may establish trust in the user's identity prior to providing the user device with a verified internal phone number. As described in more detail in FIG. 7, this established trust with the user and/or user device may be leveraged to confirm that incoming calls received from the user device are associated with a pre-authenticated user, as reflected in a corresponding DID document.

As shown by operation 402, the apparatus 200 includes means such as processor 202, memory 204, communications hardware 206, or the like for receiving a logon request for a user account. Communications hardware 206 may receive a logon request from a user device (e.g., user device 106A) when a user attempts to log into a user account using an associated software application via the user device (e.g., user device 106A). In some embodiments, the logon request may be a request to access the user account within the software application. In some embodiments, the software application is a mobile application or a native application that is configured to execute on the user device (e.g., user device 106A). The logon request may include a candidate user identifier (e.g., a username, email, customer number, and/or the like) and candidate user credentials (e.g., a shared or device-bound passkey, a password, biometric data, personal identification number (PIN), and/or the like). Additionally, or alternatively, the logon request may include an indication of the user device (e.g., user device 106A). For example, the logon request may include a device identifier. A device identifier may be a media access control (MAC) address, internet protocol (IP) address, international mobile equipment identity (IMEI) number, phone number, a mobile equipment identifier (MEID), a universally unique identifier (UDID), a hardware identifier, an electronic serial number, or any other identifier that uniquely identifies the particular user device. In some embodiments, the logon request may be received using a hypertext transfer protocol (HTTP) or HTTP secure (HTTPS) protocol (e.g., an HTTP/HTTPS request).

As shown by operation 404, the apparatus 200 includes means, such as processor 202, memory 204, authentication circuitry 208, or the like for performing an authentication routine. In some embodiments, authentication circuitry 208 may perform the authentication routine to authenticate the logon request for user account as received from the user device (e.g., user device 106A). In some embodiments, the authentication circuitry 208 may authenticate the logon request based on the received candidate user credentials and stored user credentials associated with the user account. In particular, the authentication circuitry 208 may use the candidate user identifier to determined associated stored user credentials. In an instance in which each of the received candidate user credentials sufficiently match the corresponding stored user credentials, the authentication circuitry 208 may successfully authenticate the user. Alternatively, in instance in which the received candidate user credentials fails to sufficiently match the stored user credentials, the authentication circuitry 208 may fail to authenticate the user.

For example, for a candidate user credential that is a password, the authentication circuitry 208 may use a hashing function to hash the characters of the candidate password and then compare the hashed candidate password to a hashed stored password. In an instance in which the corresponding characters of the hashed candidate password and hashed stored password exactly match, the authentication circuitry 208 may determine the candidate user credentials sufficiently match the stored user credentials.

In some embodiments, the authentication circuitry 208 may use one or more models to determine whether the candidate user credentials sufficiently match the stored user credentials. For example, in an instance in which a candidate user credential corresponds to biometric data (e.g., fingerprint data, facial image data, retina data, or the like), the authentication circuitry 208 may be configured to use one or more biometric matching machine learning models to determine whether a similarity score between biometric data of the candidate user credential and corresponding biometric data of the stored user credential. In an instance in which the similarity score satisfies one or more similarity thresholds, the authentication circuitry 208 may determine that the candidate user credential sufficiently matches the stored user credential.

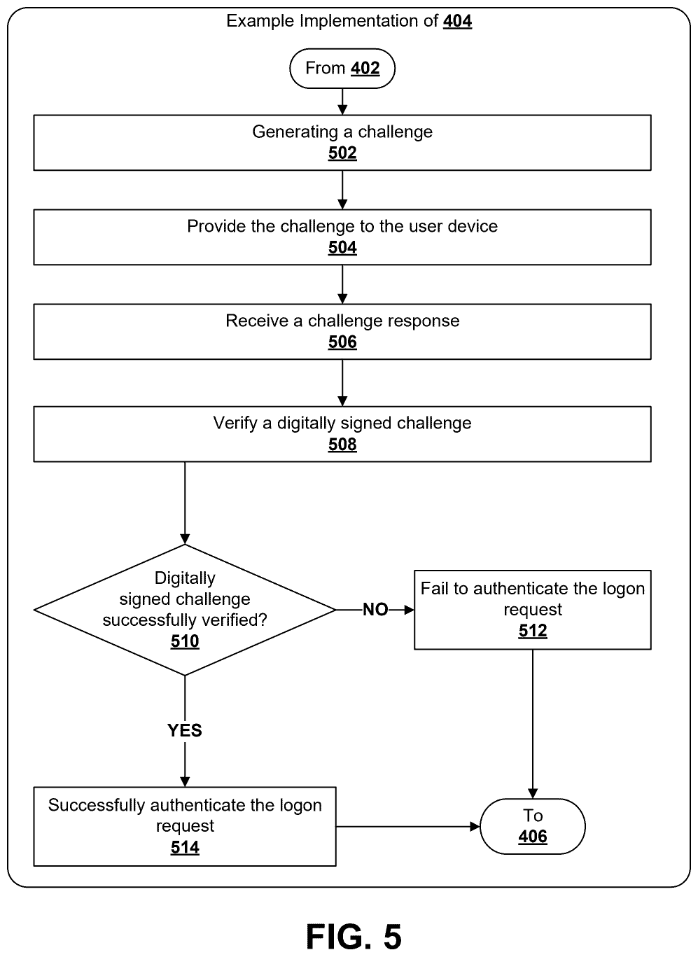

In some embodiments, operation 404 may be performed in accordance with the operations shown in FIG. 5. Turning now to FIG. 5, example operations are shown for an authentication process where the logon request is authenticated based on a digital signature provided by the user device. In some embodiments, apparatus 200 and user device (e.g., user device 106A) may have established a passkey with one another such that the logon request may be authenticated based on a passkey. A passkey may include a private cryptographic key and a corresponding public cryptographic key. The user device (e.g., user device 106A) may store the private cryptographic key, cither locally or within a cloud platform, and apparatus 200 may store a corresponding public cryptographic key within an associated memory, such as memory 204 or within a designated passkey management repository. In some embodiments, the apparatus 200 may encrypt the public cryptographic key such that it may only be accessed for an associated user and/or user device. The use of a passkey for authentication may further increase the security and trustworthiness of the user for the logon session because this method of authentication requires a pre-existing relationship between the user device (e.g., user device 106A) and apparatus 200 in order to establish a passkey.

As shown by operation 502, the apparatus 200 includes means, such as processor 202, memory 204, authentication circuitry 208, or the like for generating a challenge. In some embodiments, the authentication circuitry 208 may be configured to generate challenge to be digitally signed by the user device (e.g., user device 106A) and may use the digitally signed challenge to authenticate the logon session. The challenge may be a unique and random or pseudo-random value generated by the authentication circuitry 208. In some embodiments, the challenge includes a nonce. In some embodiments, the challenge may further include additional information, such as a timestamp, a request identifier, and/or the like, thereby increasing the uniqueness and context of the challenge.

As shown by operation 504, the apparatus 200 includes means, such as processor 202, memory 204, communications hardware 206, or the like for providing the challenge to the user device. Once the authentication circuitry 208 has generated the challenge, the communications hardware 206 may provide the challenge to the user device (e.g., user device 106A). In some embodiments, the challenge is sent to the user device using an HTTP/HTTPS protocol (e.g., an HTTP/HTTPS request).

As shown by operation 506, the apparatus 200 includes means, such as processor 202, memory 204, communications hardware 206, or the like for receiving the challenge response. In response to providing the challenge to the user device (e.g., user device 106A), the communications hardware 206 may receive a challenge response from the user device. The challenge response may include a digitally signed challenge as digitally signed by the user device. In some embodiments, the challenge response and/or digitally signed challenge is encrypted and the authentication circuitry 208 may be required to decrypt the challenge response and/or digitally signed challenge. The challenge response may be received using an HTTP/HTTPS protocol (e.g., an HTTP/HTTPS response).

As shown by operation 508, the apparatus 200 includes means, such as processor 202, memory 204, authentication circuitry 208, or the like for verifying the digitally signed challenge. The authentication circuitry 208 may verify the digitally signed challenge based on a corresponding public cryptographic key associated with the user device (e.g., user device 106A). The authentication circuitry 208 may obtain the corresponding public cryptographic key from the associated memory (e.g., memory 204) or another storage repository where the public cryptographic key is stored (e.g., a designed passkey management repository). In some embodiments, the authentication circuitry 208 may manage the storage and use of public cryptographic keys in accordance with a corresponding public key infrastructure (PKI framework of the organization associated with apparatus 200. In some embodiments, the public cryptographic key may be stored in association with a corresponding the device identifier associated with the user device (e.g., user device 106A) and/or user identifier. As such, the authentication circuitry 208 may identify a public cryptographic key associated with the user device and/or user to be used to verify the digital signature.

The authentication circuitry 208 may use the public cryptographic key to decrypt the digitally signed challenge. In an instance in which the decrypted received challenge matches the provided challenge, the authentication circuitry 208 may determine the digital signature is valid and may confirm the integrity of the challenge response and the user authenticity. As such, the authentication circuitry 208 may successfully verify the digitally signed challenge. In an instance in which the received challenge does not match the provided challenge, the authentication circuitry 208 may fail to successfully verify the digitally signed challenge.

In some embodiments, the digitally signed challenge includes a hashed version of the provided challenge, as hashed by the user device (e.g., user device 106A) using a cryptographic hash function. Thus, in some embodiments, the authentication circuitry 208 may use the public cryptographic key to decrypt the digitally signed challenge and obtain a hashed received challenge. The authentication circuitry 208 may then use the same cryptographic hash function that was used by the user device (e.g., user device 106A) to hash the provided challenge and may then compare the hash values. In an instance in which the hashed received challenge matches the hashed provided challenge, the authentication circuitry 208 may successfully verify the digitally signed challenge. In an instance in which the hashed received challenge does not match the hashed provided challenge, the authentication circuitry 208 may fail to successfully verify the digitally signed challenge.

As shown by operation 510, the apparatus 200 includes means, such as processor 202, memory 204, authentication circuitry 208, or the like for determining whether the digitally signed challenge was successfully verified. As described in operation 508, the authentication circuitry 208 may either successfully verify a digitally signed challenge received from the user device (e.g., user device 106A) or fail to successfully verify the digitally signed challenge.

In an instance in which the digitally signed challenge failed to be successfully verified by the authentication circuitry 208, the process may proceed to operation 512. As shown by operation 512, the apparatus 200 includes means, such as processor 202, memory 204, authentication circuitry 208, or the like for failing to authenticate the logon request. In an instance in which the authentication circuitry 208 fails to verify the digitally signed challenge, the authentication circuitry 208 may fail to authenticate the logon request received in operation 402.

In an instance in which the digitally signed challenge was successfully verified by the authentication circuitry 208, the process may proceed to operation 514. As shown by operation 514, the apparatus 200 includes means, such as processor 202, memory 204, authentication circuitry 208, or the like for successfully authenticating the logon request. In an instance in which the authentication circuitry 208 successfully verifies the digitally signed challenge, the authentication circuitry 208 may in turn successfully authenticate the logon request received in operation 402. In some embodiments, the authentication circuitry 208 may be required to authenticate additional candidate user credentials, as described above in operation 404. As such, the authentication circuitry 208 may successfully authenticate the logon request in an instance in which the digitally signed challenge is verified and each of the received candidate user credentials sufficiently match the corresponding stored user credentials.

Returning now to FIG. 4, as shown by operation 406, the apparatus 200 includes means, such as processor 202, memory 204, communications hardware 206, authentication circuitry 208, or the like for determining whether the logon request was successfully authenticated. As described in operation 404, the authentication circuitry 208 may perform an authentication routine to determine whether to authenticate the logon request received in operation 402.

In an instance in which the authentication circuitry 208 fails to authenticate the logon request, the process may proceed to operation 408. As shown by operation 408 includes means, such as processor 202, memory 204, communications hardware 206, authentication circuitry 208, or the like, for providing a logon error notification. A logon error notification may be indicative that the logon request failed to be successfully authenticated. In some embodiments, the logon request may be indicative of the reason for the authentication failure. For example, in an instance in which the authentication routine used a passkey but failed to verify the digitally signed challenge, the logon error notification may be indicative that the authentication using a passkey has failed. This may be due the particular user device (e.g., user device 106A) not being configured with a corresponding private cryptographic key of the passkey or the user not yet having setup a passkey with apparatus 200. The communications hardware 206 may provide the logon error notification to the user device (e.g., user device 106A) that provided the logon request. As such, the logon error notification may be indicative that the authentication using a passkey has failed and may prompt a user to retry or resubmit the logon request using different user credentials (e.g., a password, biometric data, PIN, and/or the like). In some embodiments, the user may retry or resubmit the logon request a predefined number of times (e.g., five times). After the predefined number of times has been exceeded, the user account may be temporarily locked to ensure security of the user account.

In an instance in which the authentication circuitry 208 successfully authenticates the logon request, the process may proceed to operation 410. As shown by operation 410, the apparatus 200 includes means, such as processor 202, memory 204, communications hardware 206, or the like for establishing a secure session with a user device. As described in operation 402, in some embodiments, the logon request may be received from a user device (e.g., user device 106A) via a software application using a HTTP or HTTPS protocol and may be a request to access a user account within the software application. Once the logon request has been successfully authenticated, the communications hardware 206 may provide a response (e.g., an HTTP/HTTPS response) that includes user account data for the user account to the software application running on the user device (e.g., user device 106A). In some embodiment, the communications hardware 206 may use specific application program interfaces (APIs), such as representational state transfer APIs (RESTful APIs) or WebSocket APIs to provide user account data to the software application.

Once the user account data is provided to the software application running on the user device (e.g., user device 106A), the secure session may be successfully established. The authenticated session may continue until a termination event occurs. A termination event may be the user logging out of the session. Alternatively, the termination event may be a timeout event, where the software application running on the user device (e.g., user device 106A) experiences a period of inactivity for a length of time that exceeds an inactivity time threshold (e.g., 10 minutes). In an instance a termination event occurs, the user may be required to provide another logon request to establish a new authenticated session or re-establish the authenticated session.

As shown by operation 412, the apparatus 200 includes means such as processor 202, memory 204, communications hardware 206, or the like for receiving a call request from the user device. After establishing secure session with the user device, the communications hardware 206 may receive a call request from the user device over the secure session. The call request may be indicative of a request from the user to be connected with a verified agent associated with apparatus 200 (e.g., an employee of the institution that operates apparatus 200). In some embodiments, the call request may be received in response to user input provided to the user device (e.g., user device 106A) as discussed in greater detail in FIG. 10. In some embodiments, the call request may be received using a HTTP/HTTPS protocol (e.g., an HTTP/HTTPS request). In some embodiment, the communications hardware 206 may receive the call request over specific APIs, such as RESTful APIs or WebSocket APIs.

In some embodiments, the call request includes call context information. The call context information may be indicative of one or more reasons the user desires a call with a verified agent. As such, the call context information may be used to help determine an appropriate verified internal phone number to meet the needs of the user. For example, the call context information may be indicative of a particular software application page, page data, or software application page history that the user was viewing or had recently viewed when the call request was provided. In some embodiments, the user may manually the call context information, such as in free form text, as a categorical selection from a drop-down menu or other user interface elements, via a recorded voice memo, and/or the like. By way of particular example, the call context information may be indicative that a user needs assistance with changing his/her password, needs to report a lost or stolen banking card and/or ordering a replacement banking card, has questions about his/her banking statements and/or various accounts, wishes to lodge a complaint, seeks account or service advice, and/or the like.

In some embodiments, the call request may further include call request metadata. The call request metadata may describe various metadata for the call request. For example, call request metadata may include a timestamp and date indicative of the time and date that the call request was provided by the user device (e.g., user device 106A). In some embodiments, the call request metadata may further include a location of the user device (e.g., user device 106A) providing the call request. For example, the call request metadata may include an absolute location of the user device, such as global positioning system (GPS) coordinates (e.g., a longitude and latitude), and/or a relative position of the user device with respect to a point of interest (e.g., a distance from the nearest physical brick-and-mortar location of a branch associated with apparatus 200).

In some embodiments, the call request may include a request for a particular agent. For example, the user may have a pre-existing relationship with the agent and may wish to be connected to this agent for the call. The call request may include the agent's name and/or one or more agent identifiers (e.g., email address, phone number, extension).

As shown by operation 414, the apparatus 200 includes means such as processor 202, memory 204, communication management circuitry 210, or the like for determining a verified internal phone number. Upon receipt of the call request from the user device (e.g., user device 106A), the communication management circuitry 210 may determine a verified internal phone number to provide the requesting user device. A verified internal phone number may be a phone number that is known to be associated with the institution that operates apparatus 200. In some embodiments, a verified internal phone number may correspond to a particular group, department, or individual agent (e.g., an employee of the institution that operates apparatus 200). As such, the verified internal phone number may a trusted, verified phone number that may be used by a user device (e.g., user device 106A) to securely connect the user and an agent.

In some embodiments, apparatus 200 may be configured with a direct inward dialing system that allows for department-specific call routing. As such, different verified internal phone numbers may correspond to different departments, teams, groups, or individuals. In particular, in some embodiments, apparatus 200 may facilitate incoming phone calls using a private branch exchange (PBX) system, an IP PBX system, a VoIP system, a cloud-based system, and/or the like. This allows for the assignment of a verified internal phone number to a particular department, team, group, etc. Thus, the communication management circuitry 210 to determine a verified internal phone number that corresponds to a particular department rather than a particular agent. As such, upon dialing the particular verified internal phone number, the call from the user device (e.g., user device 106A) may be routed to the next available agent within the department that may assist the user with the particular inquiry. In some embodiments, a verified internal phone number may further correspond to a sub-group within a department, team, or group. For example, a verified internal phone number may correspond to a night-shift team within a fraud handling department.

In some embodiments, the communication management circuitry 210 may determine a call request reason based on the call context information. A call request reason may be a predefined categorical value that may be assigned to the call request and may be indicative of a reason for the call request. The communication management circuitry 210 may use the call request reason to determine the verified internal phone number. In some embodiments, the communication management circuitry 210 may directly determine the call request reason from the call context information. For example, in an instance that the user provided a selection from a drop-down menu or predefined user interface element, the communication management circuitry 210 may determine the call request reason corresponds to the selection made by the user.

In some embodiments, the communication management circuitry 210 may further process the call context information to determine a call request reason. For example, in some embodiments, the communication management circuitry 210 may use natural language processing (NLP) techniques to identify keywords from text-based user-provided call context information. In some embodiments, in an instance that a user provides a voice memo, the audio from the voice memo may be converted to text using a speech-to-text (STT) technique and then analyzed for keywords. The communication management circuitry 210 may use these identified keywords to determine a call request reason. For example, communication management circuitry 210 may process the call context information to identify the keywords of “fraud,” “assistance,” “dispute,” “compromised,” and “suspicious charge.” As such, the communication management circuitry 210 may determine a call request reason of “potential fraud assistance.”

In some embodiments, the communication management circuitry 210 may determine the call request reason based on an indication of recent or the most recent software application page visited by the user prior to receiving the call request. In some embodiments, each software application page may be associated with one or more call request reasons. In some embodiments, a software application page list may include entries for each software application page and/or respective endpoint and a corresponding call request reason associated with the software application page. As such, the communication management circuitry 210 may use the software application page list to determine a call request reason. By way of particular example, the user may have provided the call request while accessing a software application page for a lost or stolen debit card. The communication management circuitry 210 may use the software application page list to determine that the particular software application page is associated with a call request reason of “lost or stolen bank card.”

Once the communication management circuitry 210 has determined a call request reason, the communication management circuitry 210 may use a call routing protocol to determine the verified internal phone number. The call routing protocol may define a series of rules and/or operations to perform to determine the verified internal phone number. In some embodiments, the call routing protocol may define the use of one or more call routing structures configured with rules and/or logic to determine a verified internal phone number to facilitate the call request. A call routing structure may be any structure such as a lookup table, linked list, tree structure (e.g., a decision tree), graph network structure, matrix, and/or the like. The communication management circuitry 210 may use the call request reason, call context information, call request metadata, or other information from the call request to determine the verified internal phone number using the call routing structure.

For example, the call routing protocol may be indicative for communication management circuitry 210 to use a decision tree call routing structure to determine the verified internal phone number. The communication management circuitry 210 may traverse the tree structure from a root node to a terminal node, which may include a verified internal phone number. This may allow the communication management circuitry 210 to determine the verified internal phone number by traversing the decision tree. By way of particular example, the communication management circuitry 210 may determine a call request reason of “potential fraud assistance.” The first level nodes of the decision tree may each correspond to a different call request reason and the communication management circuitry 210 may traverse the decision tree to the first level node corresponding to the “potential fraud assistance” call request reason. A second node of the decision tree structure may correspond to different geographic areas and/or locations. As such, the communication management circuitry 210 may traverse the nodes of the decision tree structure based on the location of the user device as indicated by the call request metadata. In some embodiments, a third node of the decision tree structure may correspond to a time window (e.g., 9 AM-5 PM EST and 5:01 PM-8:59 AM EST). As such, the communication management circuitry 210 may traverse the nodes of the decision tree structure based on the timestamp the call request was provided as indicated by the call request metadata. In some embodiments, a fourth node of the decision tree structure may correspond to a date (e.g., holidays and non-holidays). As such, the communication management circuitry 210 may traverse the nodes of the decision tree structure based on the date the call request was provided as indicated by the call request metadata. A fifth level node may be the terminal node and may be indicative of the verified internal phone number. The communication management circuitry 210 may continue traversing the decision tree to the terminal node to determine the verified internal phone number.

As another example, the call routing protocol may be indicative for communication management circuitry 210 to use a lookup table call routing structure to determine the verified internal phone number. The lookup table may be configured to store verified internal phone numbers along with various criteria associated with each verified internal phone number. For example, a particular verified internal phone number may be associated with a particular call request reason, geographic area and/or location, time window, and/or date. As such, the communication management circuitry 210 may use the determined call request reason and call request metadata (e.g., a location, timestamp, and/or date) as input and the lookup table may output a corresponding verified internal phone number.

It will be appreciated that the above example call routing structures are merely examples and any suitable call routing structure may be contemplated for the call routing protocol to determine the verified internal phone number.

In some embodiments, the verified internal phone number may correspond to a particular agent. For example, in an instance in which the call request is indicative of a request for a particular agent, the communication management circuitry 210 may use the agent's name and/or agent identifiers provided in the call request to identify the requested agent. In particular, within the direct inward dialing system may define an agent profile the includes the agent's name, email address, department, group, team, locality or region, expertise, working hours, workdays, etc. as well as a verified internal phone number for the agent. As such, in an instance that the call request is indicative of a request for a particular agent, the communication management circuitry 210 may be configured to use the provided agent name and/or identifiers to identify the requested agent profile corresponding to the requested agent. The communication management circuitry 210 may determine whether the requested agent is currently working or available (e.g., based on the working hours and workdays in the agent profile) and in an instance in which the agent is currently working or available, the communication management circuitry 210 may determine the verified internal phone number corresponding to the agent. In an instance in which the requested agent is not working or otherwise unavailable, the communication management circuitry 210 may determine a verified internal phone number for a different agent and may include the next available time and date the requested agent is available. Thus, the user may make a decision whether he/she would like to proceed with the call or wait until the requested agent is available.

As shown by operation 416, apparatus 200 includes means such as processor 202, memory 204, communications hardware 206, or the like for providing the verified internal phone number to the user device. Once the communication management circuitry 210 has determined a verified internal phone number to facilitate the call request, the communication management circuitry 210 may provide the verified internal phone number to the user device (e.g., user device 106A). The verified internal phone number may be provided with software instructions that when executed by the user device (e.g., user device 106A), cause the user device to perform a call using the verified internal phone number. As described in further detail in FIG. 10, the user may interact with a user interface element associated with the verified internal phone number to cause the user device (e.g., user device 106A) to perform a call using the verified internal phone number. In some embodiments, the communications hardware 206 may provide the verified internal phone number using a HTTP/HTTPS protocol (e.g., an HTTP/HTTPS response). In some embodiment, the communications hardware 206 may provide the verified internal phone number over specific APIs, such as RESTful APIs or WebSocket APIs.

In some embodiments, in an instance the call request was indicative of a request for a particular agent, an indication of whether the requested agent was available may be provided to the user device (e.g., user device 106A). For example, if the requested agent is currently available, the communications hardware 206 may further provide an indication confirming that the verified internal phone number corresponds to the requested agent and may further include the working hours for the requested agent. As another example, if the requested agent is not available, the communications hardware 206 may further provide an indication that the requested agent is currently unavailable and may further include a next available time and/or date that the requested agent is available. The communications hardware 206 may also provide a verified internal phone number for a different agent. In some embodiments, the communications hardware 206 may further includes software instructions that allow for the user to request a call back from the requested agent at a particular time and/or date. If the communications hardware 206 receives a request for a call back from the user device (e.g., user device 106A), the communication management circuitry 210 may update an agent profile and/or agent work queue to alert the agent to call the user.

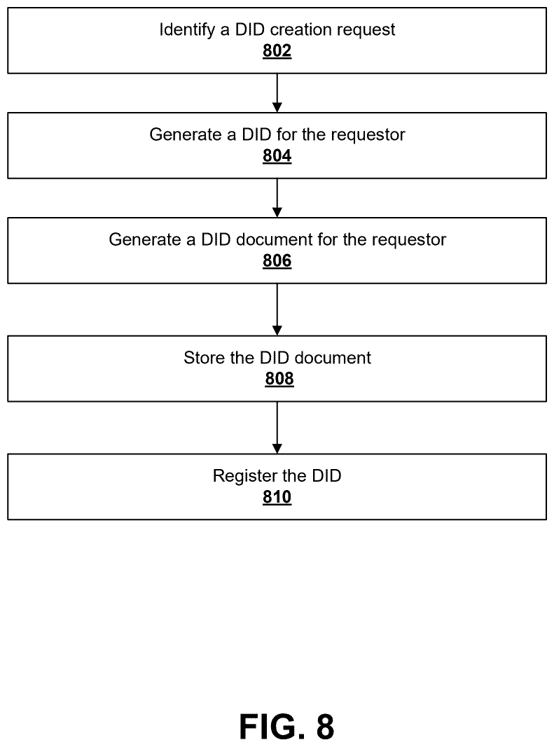

As shown by operation 418, apparatus 200 includes means such as processor 202, memory 204, communications hardware 206, blockchain management circuitry 212, or the like for updating a DID document associated with a user DID. As described in further detail in FIG. 8, a user may be assigned a unique DID that is representative of a globally unique, digital identity for the user. In some embodiments the user DID may be included in a user account. In some embodiments, the user DID may be stored in an encrypted manner. The blockchain management circuitry 212 may access the user DID and if needed, may decrypt the user DID, from the user profile and then use the user DID to update a DID document. In some embodiments, the user DID may be registered on a distributed ledger or blockchain, such as DID storage repository 112. The user DID may be associated with a corresponding DID document. In some embodiments, the user DID may also be registered with a cryptographic hash of the corresponding DID document and/or additional metadata (e.g., a link to the storage location of the corresponding DID document or the like). In some embodiments, the DID document may be stored within an associated storage system, such as communications storage repository 114.

In some embodiments, the blockchain management circuitry 212 may use a DID resolver to look up the user DID that is stored and/or registered in the DID storage repository 112 (e.g., a distributed ledger or blockchain). The blockchain management circuitry 212 may use a DID resolver with the DID method of the user DID to query DID storage repository 112 and the query may retrieve the latest transaction related to the user DID, including the hash and/or reference to a corresponding DID document. The blockchain management circuitry 212 may then access the DID document and update an associated call request log to reflect the received call request from the user device (e.g., user device 106A). The blockchain management circuitry 212 may update the call request log to include pertinent call request details, such as the call context information, the call request metadata, the determined call request reason, a requested agent indicated in the call request, the provided verified internal phone number, and/or the like.

Once the DID document has been updated, the blockchain management circuitry 212 may be configured to digitally sign the updated DID document using a private cryptographic key associated with a public cryptographic key included in the DID document. As described in further detail in FIG. 8, the blockchain management circuitry 212 may be configured to generate a private cryptographic key and public cryptographic key when generating the DID document. These private cryptographic key and public cryptographic key may be different cryptographic keys than the private cryptographic key and public cryptographic key used to authenticate the user device (e.g., user device 106A), as described in FIG. 5. The blockchain management circuitry 212 may then determine the hash of the updated DID document and submit a new transaction that includes the user DID, the digital signature signed using the private cryptographic key, and the updated hash of the DID document along with any desired additional metadata (e.g., a reference to the storage location of the DID document) to the DID storage repository 112. By digitally signing the transaction, the blockchain network (e.g., DID storage repository 112) may verify the transaction using the public cryptographic key from the DID document. If the digital signature is valid, the blockchain network may record the updated information in user DID. As such, the user DID within the DID storage repository 112 may be configured with the transaction history of all changes or updates made to the DID document. In an instance in which the user DID is resolved by blockchain management circuitry 212, the blockchain management circuitry 212 may retrieve the most recent transaction of the user DID and thus, may access the most recent DID document for the user. Additionally, by authenticating updates to the DID document, this ensures that no unauthorized updates are made to the DID document.

In some embodiments, A DID document may be formatted as a JavaScript Object Notation for Linked Data (JSON-LD) file. The DID document associated with the user DID may include one or more elements. For example, the DID document may include industry-standard elements such as the corresponding user DID, a set of public cryptographic keys associated with the user DID, a set of authentication methods to be used for authentication, and a set of service endpoints. Additionally, in some embodiments, the DID document may further include a call request log that may reflect information pertaining to call requests received from the user device (e.g., user device 106A) associated with the user. As described above, the call request log may include pertinent call request details for each received call request pertaining to the user, such as the call context information, the call request metadata, the determined call request reason, a requested agent indicated in the call request, the provided verified internal phone number, and/or the like.

Additionally, the call request log may include a call status for each call request. The call status may be indicative of a current status pertaining to a call associated with the call request. For example, call request statuses may include “pending,” “completed,” “expired,” “cancelled,” and/or the like. In some embodiments, the blockchain management circuitry 212 may update the call request status for a DID document based on whether it receives confirmation of a user call from the communication management circuitry 210 within a predefined time frame (e.g., within 10 minutes from receipt of the call request). By way of particular example, a blockchain management circuitry 212 may set an initial call request status to “pending” for a new call request in the call request log. If the blockchain management circuitry 212 fails to receive confirmation that a call has been received from the user device (e.g., user device 106A) within the predefined time frame (e.g., 10 minutes), then the blockchain management circuitry 212 may update the call request status to “expired.” Alternatively, if blockchain management circuitry 212 receives confirmation that a call has been received from the user device (e.g., user device 106A) within the predefined time frame, then the blockchain management circuitry 212 may update the call request status to “completed.” Additionally, if blockchain management circuitry 212 receives an indication from the communication management circuitry 210 that the user has cancelled a call request, the blockchain management circuitry 212 may update the call request status to “expired.” As such, the DID document corresponding to the user DID may reflect a current state of the call request for the user such that incoming call requests may be facilitated in a secure and protected manner. The call request status for the call request within the DID document ensures that the call request is only valid for a predefined amount of time. As such, this enhances security and protection of the user account by reducing the risk that would-be fraudsters could be authenticated for a user account if they were to use the user device (e.g., user device 106A) or spoof the user device at a later time occurring outside the predefined time window.

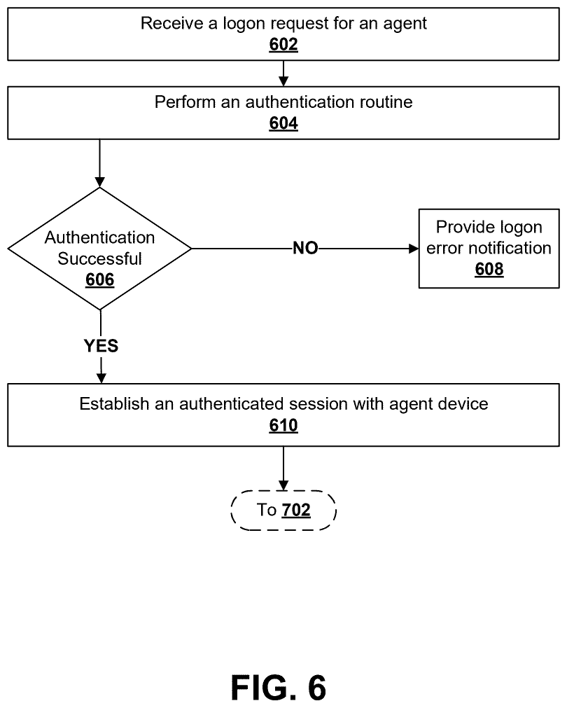

Additionally, the DID document may further include a device list that may reflect one or more user devices (e.g., any one of user devices 106A-106N) that are known to be associated with user. In some embodiments, the device list may include an entry for each known user device associated with the user. Additionally, the device list may include one or more device identifiers for each user device entry. For example, a user device (e.g., user device 106A) may be associated device identifiers such as a phone number, a MAC address, an IP address, a IMEI number, a MEID, a UDID, a hardware identifier, an electronic serial number, and/or the like. As such, the device list within the DID document may serve to verify whether a particular user device is known to be associated with the user. Turning now to FIG. 6, example operations are shown for establishing a secure session with an agent device. Apparatus 200 may authenticate an agent prior to establishing a connection between a corresponding agent device and a user device. As such, apparatus 200 may establish trust in the agent's identity prior to connecting him/her with a user. As described in more detail in FIG. 7, this established trust with the agent and/or agent device may be leveraged to confirm that an incoming call routed to the agent device are associated with a pre-authenticated agent. Additionally, apparatus 200 may perform the operations of FIG. 4 and FIG. 6 in parallel, such as by using parallel processing techniques. As such, apparatus 200 may facilitate establishment of a secure session with an agent device, as described in FIG. 6 and handle a logon request as described in FIG. 4.

As shown by operation 602, the apparatus 200 includes means such as processor 202, memory 204, communications hardware 206, or the like for receiving a logon request for an agent account. Communications hardware 206 may receive a logon request from an agent device (e.g., agent device 108A), such as when an agent attempts to access an associated agent account within an internal account environment. The logon request may include a candidate agent identifier (e.g., a username, email, employee number, and/or the like) and candidate agent credentials (e.g., a shared or device-bound passkey, a password, biometric data, PIN, and/or the like). Additionally, or alternatively, the logon request may include an indication of the agent device (e.g., agent device 108A). For example, the logon request may include a device identifier. A device identifier may be a MAC address, IP address, IMEI number, a phone number, a MEID, a UDID, a hardware identifier, an electronic serial number, or any other identifier that uniquely identifies the particular user device. In some embodiments, the logon request may be received using a HTTP or HTTPS protocol (e.g., an HTTP/HTTPS request).

In some embodiments, the agent may be an authorized user associated with the identity authentication management system 102 (e.g., an employee, contractor, or other authorized party). An agent may also be associated with an agent account that may be stored and maintained in an associated memory (e.g., memory 204 or another data repository). The agent account may further be associated with an agent identifier (e.g., a username, email, employee number, and/or the like) and agent credentials (e.g., a password, biometric data, PIN, and/or the like). The communication management circuitry 210 may identify a particular agent using the agent identifier and authenticate the agent based on the associated agent credentials.

The agent profile may also include a set of permissions that allow the agent to access certain data or information within the identity authentication management system 102 that other unauthorized users would not be able to access. For example, a set of permissions associated with the agent may allow the agent to use the agent device (e.g., agent device 108A) to access user information (e.g., user account information, a DID document associated with the user, or the like) within an internal account environment. Additionally, the set of permissions may allow the agent to provide certain data (e.g., a received confirmation code or the like) to the communications hardware 206 and the apparatus 200 may take further action (e.g., providing an indication that the call is with an authorized user and/or authorized agent).

As shown by operation 604, the apparatus 200 includes means, such as processor 202, memory 204, authentication circuitry 208, or the like for performing an authentication routine. In some embodiments, authentication circuitry 208 may perform the authentication routine to authenticate the logon request for agent account as received from the agent device (e.g., agent device 108A). In some embodiments, the authentication circuitry 208 may authenticate the logon request based on the received candidate agent credentials and stored agent credentials associated with the agent account. In particular, the authentication circuitry 208 may use the candidate agent identifier to determined associated stored agent credentials. In an instance in which each of the received candidate agent credentials sufficiently match the corresponding stored agent credentials, the authentication circuitry 208 may successfully authenticate the agent. Alternatively, in instance in which the received candidate agent credentials fails to sufficiently match the stored agent credentials, the authentication circuitry 208 may fail to authenticate the agent. In some embodiments, the authentication circuitry 208 may perform the authentication routine to authenticate the agent in a substantially similar manner as described in operation 404 in FIG. 4 and/or as further described in FIG. 5.

As shown by operation 606, the apparatus 200 includes means, such as processor 202, memory 204, communications hardware 206, authentication circuitry 208, or the like for determining whether the logon request was successfully authenticated. As described in operation 604, the authentication circuitry 208 may perform an authentication routine to determine whether to authenticate the logon request received in operation 602.

In an instance in which the authentication circuitry 208 fails to authenticate the logon request, the process may proceed to operation 608. As shown by operation 608 includes means, such as processor 202, memory 204, communications hardware 206, authentication circuitry 208, or the like, for providing a logon error notification. A logon error notification may be indicative that the logon request failed to be successfully authenticated. In some embodiments, the logon request may be indicative of the reason for the authentication failure. For example, in an instance in which the authentication routine used a passkey but failed to verify the digitally signed challenge, the logon error notification may be indicative that the authentication using a passkey has failed. This may be due the particular agent device (e.g., agent device 108A) not being configured with a corresponding private cryptographic key of the passkey or the agent not yet having setup a passkey with apparatus 200. The communications hardware 206 may provide the logon error notification to the agent device (e.g., agent device 108A) that provided the logon request. As such, the logon error notification may be indicative that the authentication using a passkey has failed and may prompt the agent to retry or resubmit the logon request using different agent credentials (e.g., a password, biometric data, PIN, and/or the like).

In an instance in which the authentication circuitry 208 successfully authenticates the logon request, the process may proceed to operation 610. As shown by operation 610, the apparatus 200 includes means, such as processor 202, memory 204, communications hardware 206, or the like for establishing an authenticated session with the agent device. As described in operation 602, in some embodiments, the logon request may be received from an agent device (e.g., agent device 108A) using a HTTP or HTTPS protocol and may be a request to access an agent account within an internal account environment. Once the logon request has been successfully authenticated, the communications hardware 206 may provide a response (e.g., an HTTP/HTTPS response) that includes agent account data for the agent account for the internal account environment.

Once the agent account data is provided to the agent device (e.g., agent device 108A), the authenticated session may be successfully established. The authenticated session may continue until a termination event occurs. A termination event may be the agent logging out of the session. Alternatively, the termination event may be a timeout event, where the agent device (e.g., agent device 108A) experiences a period of inactivity for a length of time that exceeds an inactivity time threshold (e.g., 10 minutes). In an instance a termination event occurs, the agent may be required to provide another logon request to establish a new authenticated session or re-establish the authenticated session.

Turning now to FIG. 7, example operations are shown for handling an incoming call from a user device. As described in FIG. 4, apparatus 200 may receive a call request from the user device (e.g., user device 106A) during a secure session and provide a verified internal phone number to the user device. In an instance in which the user device performs a call (e.g., a call over a telecommunications network, cellular network, a VoIP system, or the like), apparatus 200 may receive the incoming call from the user device. The apparatus 200 may further use the DID document of the user, a provided device identifier associated with the user device, and/or additional authentication events to authenticate the incoming call from the user device. In doing so, authentication of the user may be streamlined and an indication of the authentication status of the user may be provided to a corresponding agent. Additionally, apparatus 200 may connect the user device to an agent device that is associated with an authenticated session and may provide confirmation to the user that the agent he/she is connected with is an authorized and affiliated agent. Thus, both parties on the call may be provided with an indication of the other party's authentication status to establish mutual trust.

As shown by operation 702, the apparatus 200 includes means, such as processor 202, memory 204, communications hardware 206, or the like for receiving a notification of an incoming call from a user device. As described in more detail in FIG. 10, the user device (e.g., user device 106A) may initiate a call to the verified internal phone number over any suitable network, such as communications network 104 (e.g., a telecommunications network, cellular network, VoIP service, or the like). In response to this call, communications hardware 206 may receive a notification of the incoming call from the user device (e.g., user device 106A) along with call information. The communications hardware 206 need not directly receive the call but instead may receive only call information pertaining to the incoming call. For example, the incoming call may be received by a call routing system and the communications hardware 206 may receive a notification of the incoming call from the call routing system.

In some embodiments, the call information may include a device identifier. A device identifier may be the phone number of the user device (e.g., user device 106A) performing the incoming call. The call information may also include the dialed number, which is the phone number the caller dialed to indicate the destination of the incoming call. The dialed number may be the verified internal phone number. The call information may further include call metadata, such as the time of the call, the duration of the call, the type of call (e.g., mobile, landline, VOIP, or the like), etc.

In some embodiments, the call information may include additional device identifiers. For example, in a VoIP call, the user device (e.g., user device 106A) may additionally provide a MAC address, IP address, IMEI number, a MEID, a UDID, a hardware identifier, an electronic serial number, or any other identifier that uniquely identifies the particular user device. Additionally, the call information may include supplemental information, such as location information indicative of the geographic location of the user device (e.g., user device 106A), quality of services metrics, encryption, and security information, and/or the like. In some embodiments, these additional device identifiers may be provided using various protocols, such as a session initiation protocol, a session description protocol, a real-time transport protocol, and/or the like.

In some embodiments, the communication management circuitry 210 may cause the call from the user device (e.g., user device 106A) to be placed in a virtual holding area until the user device and/or call request can be authenticated. In some embodiments, the virtual holding area may use an interactive voice response (IVR) system to interact with the user. In some embodiments, the IVR system may request additional information from the user such as prompting them for additional information regarding the call and/or other information. The communications hardware 206 may receive this provided information.

As shown by operation 704, the apparatus 200 includes means, such as processor 202, memory 204, communication management circuitry 210, or the like for identifying a user account associated with the device identifier. The communication management circuitry 210 may use the device identifier provided in the call information to identify a user account associated with the device identifier. A user account may be associated with the device identifier such that a user account associated with the user may be identified by querying for user accounts, which include the device identifier. A user account may include user device information for user devices associated with the user. For example, users may add trusted user devices to his/her user account and a resulting user device profile may be generated and maintained for the user device within the user account. The user device profile may include the device identifiers (e.g., a phone number, MAC address, IP address, IMEI number, a MEID, a UDID, a hardware identifier, an electronic serial number, or any other identifier that uniquely identifies the particular user device) associated with the user device. As such, a corresponding user profile may be identified using a device identifier. The user device profile may also include additional user device information, such as a trust score indicative of the level of trustworthiness determined for the user device. As another example, the user device profile may include user device permissions, indicative of user-defined permissions or actions that the user device may perform with respect to the user account.

A user account may also contain user information (e.g., name, email, phone number, address, and/or the like) as well as user account information. By way of particular example, apparatus 200 may be associated with a financial institution where a user may have one or more user accounts (e.g., checking, savings, loans, and/or the like). Thus, a user account may be associated with an account balance, transaction record, and/or the like. Additionally, a user account may be associated with user credentials (e.g., username, password, PIN, biometric data, and/or the like) that may be provided by a user to access his/her corresponding user account. Additionally, the user account may include a user DID that may represent a unique, digital identity for the user.

In some embodiments, the communication management circuitry 210 may identify the user account by querying for a device identifier. For example, the communication management circuitry 210 may query a user account database for a phone number (e.g., a device identifier) corresponding to call information for the incoming call. The query results may return a single user account associated with the user device. The communication management circuitry 210 may then identify the user account based on the results of the query. For incoming calls that occur over a landline or cellular network, the device identifier may be the phone number of the user device (e.g., user device 106A).

In an instance in which the incoming call occurs over a different communication channel, such as over VoIP, additional device identifiers may be provided by the corresponding call information. In some embodiments, the communication management circuitry 210 may be configured to query a user account database for one or more of these additional device identifiers. In some embodiments, the communication management circuitry 210 may query a user account database for a phone number to identify a user account associated with the user device and then use the additional device identifiers (e.g., MAC address, IP address, IMEI number, a MEID, a UDID, a hardware identifier, an electronic serial number, or any other identifier) to confirm the identity of the user device. If each of the additional device identifiers match the stored device identifiers for the user device profile determined to correspond to the phone number, then the communication management circuitry 210 may confirm the user device identity. If the user device identity is confirmed, the communication management circuitry 210 may identify the user account associated with the user device profile.

Alternatively, if an additional device identifier does not correspond (e.g., does not match) a stored device identifier for the user device profile determined to correspond to the phone number, the communication management circuitry 210 may perform additional actions. In some embodiments, if additional device identifiers are not found to correspond to stored device identifiers, the communication management circuitry 210 may cause the incoming call to be routed through a conventional call routing system, as described in further detail in operation 708. In some embodiments, if additional device identifiers are not found to correspond to stored device identifiers, the communication management circuitry 210 may still identify the user account but may flag the incoming call as requiring additional authentication protocols. As described in more detail in operations 712 and/or 716, the additional authentication protocols may require the user to perform additional authentication operations and/or supply additional information prior to the user identity and/or user device identity being authenticated for the incoming call. In some embodiments, the communications hardware 206 may provide a warning notification using various communication channels (e.g., email, text, software application push notifications, or the like) to alert the user of the potentially spoofed call. As such, the communication management circuitry 210 may proactively confirm the identity of the user device using additional device identifiers that cannot be replicated by a spoofing device and thereby reduces the likelihood that the incoming call is from a spoofed phone number.

In some embodiments, the communication management circuitry 210 may further identify a user DID within the identified user account. As described in further detail in operation 706, the user DID may be used to access an associated DID document. The DID document may be indicative of whether the user device provided a call request.

At operation 706, the apparatus 200 includes means, such as processor 202, memory 204, communications hardware 206, blockchain management circuitry 212, or the like for determining whether a DID document is indicative of a call request. As described in operation 418 of FIG. 4, during a secure session with the user device (e.g., user device 106A) and in response to providing a verified internal phone number, the blockchain management circuitry 212 may update a DID document associated with the user DID to reflect the call request. Responsive to receiving an incoming call from the user device, the blockchain management circuitry 212 may be used to access the DID document and determine whether the DID document is indicative of a call request. In an instance in which the DID document is indicative of the call request, this may demonstrate that the incoming call from the user device (e.g., user device 106A) has been pre-staged and that the user and/or user device have been authenticated via an authentication routine as performed in operation 404 of FIG. 4. As such, the user and/or user device may be trusted during the incoming call and thus, the user may not be required to perform additional authentication procedures as required during conventional incoming calls, which may reduce user friction and improve the overall user experience.

To determine whether the DID document is indicative of the call request, the blockchain management circuitry 212 may determine the user DID within the user account and may decrypt the user DID if needed. The blockchain management circuitry 212 may then identify the method used to look up the user DID stored in the DID storage repository 112 (e.g., a distributed ledger or blockchain). The blockchain management circuitry 212 may use a DID resolver with the DID method of the user DID to query DID storage repository 112 and the query may retrieve the latest transaction related to the user DID, including the hash and/or reference to the DID document. The blockchain management circuitry 212 may use the hash and/or reference to fetch or otherwise obtain the DID document from its storage location, such as within the communications storage repository 114. In some embodiments, the blockchain management circuitry 212 may verify the DID document by determining the hash of the retrieved DID document and comparing it to the hash of the DID document obtained from the query. If the hashes match, the blockchain management circuitry 212 may use the DID document to determine whether it is indicative of a call request. Otherwise, the blockchain management circuitry 212 may reattempt the query and/or reattempt to fetch or obtain the correct DID document from communications storage repository.

As described above, the DID document may include a call request log that reflects received call requests from the user device. The blockchain management circuitry 212 may determine whether the call request log from the retrieved DID document is indicative of call request associated with an active call request status, such as “pending.” In an instance the call request log is indicative of a call request associated with an active call request status, the blockchain management circuitry 212 may determine the DID document is indicative of a call request. Additionally, the blockchain management circuitry 212 may identify call request details associated with the call request associated with an active status. For example, the blockchain management circuitry 212 may identify call context information, call request metadata, a determined call request reason, a requested agent indicated in the call request, the provided verified internal phone number, and/or the like. The blockchain management circuitry 212 may provide the call request details to communication management circuitry 210 to aid in the selection of an agent device as described in further detail in operation 710.

If there are no call requests associated with an active call request status (e.g., no call requests in the call request log or only call requests associated with a “completed,” “expired,” or “cancelled” call request status), the blockchain management circuitry 212 may determine the DID document is not indicative of a call request.

In an instance in which the DID document fails to be indicative of a call request, the process may proceed to operation 708. At operation 706, the apparatus 200 includes means, such as processor 202, memory 204, communications hardware 206, communication management circuitry 210, or the like for routing the call through the call routing system. In an instance in which the DID document fails to be indicative of a call request, apparatus 200 may be unable to confirm the identity of the user and/or user device for the incoming call. As such, the communication management circuitry 210 may cause the incoming call to be routed through the conventional call routing system. In some embodiments, the conventional call routing system is an automated call distributor that may include an IVR. The conventional call routing system may still allow the incoming call to be connected with an authorized agent but may require the user to participate in additional authentication protocols because the user identity and/or user device identity cannot be confirmed. In some embodiments, the user may still be provided with an indication that the current call is with an authorized agent as described in further detail in operation 714 and/or may be provided with agent information as described in further detail in operations 718-720. As such, the user may still be assured he/she is speaking with an authorized agent.

In an instance in which the DID document is indicative of a call request, the process may proceed to operation 710. At operation 710, the apparatus 200 includes means, such as processor 202, memory 204, communication management circuitry 210, or the like for selecting an agent associated with an authenticated session. In an instance in which the blockchain management circuitry 212 determines the DID document is indicative of the call request, this may aid apparatus 200 in confirming the identity of the user and/or user device. Thus, the communication management circuitry 210 may select an agent to facilitate the incoming call from the user device such that the user is not required to go through the conventional call routing system.

In particular, the communication management circuitry 210 may select an agent that is currently associated with an authenticated session. As described in FIG. 6, an agent may provide a logon request using an agent device (e.g., agent device 108A) and an authentication routine may be performed to authenticate the logon request. If the logon request is successfully authenticated, the authenticated session may be established with the agent. In some embodiments, the communication management circuitry 210 may generate and maintain an agent session list, which may include an entry for an agent identifier and a corresponding authenticated session status. The authenticated session status may be indicative of whether the agent currently has an active authenticated session with an agent device. For example, an authenticated session status may be “active” if the agent currently has an authenticated session via an agent device or “inactive” if the agent does not currently have an authenticated session via an agent device. The communication management circuitry 210 may update the agent session list entries based on the operations described in FIG. 6. The communication management circuitry 210 may filter out agents who are not currently associated with an active authenticated session and may select an agent associated with an active authenticated session. Thus, the communication management circuitry 210 may ensure that the agent with whom the user is to be connected has also been authenticated and can be trusted.

As described in operation 414, the communication management circuitry 210 may provide a verified internal phone number based on the call context information, a call request reason, call request metadata, etc. The verified internal phone number may correspond to a particular team, department, group, or individual. In some embodiments, the agent session list may also include one or more verified internal phone numbers, departments, groups, etc. for each agent identifier entry. The communication management circuitry 210 may additionally filter agents within the agent session list based on the dialed number (e.g., verified internal phone number) associated with the incoming call. As such, the communication management circuitry 210 may also filter out agents who are not associated with the department, group, etc. that corresponds to the dialed number.

Once the communication management circuitry 210 has filtered agents based on an authenticated session status and/or associated verified internal phone numbers, the communication management circuitry 210 may select an agent to facilitate the call. In some embodiments, the communication management circuitry 210 may be configured with one or more mathematical and/or logical operations and/or rules for selecting an agent. For example, the communication management circuitry 210 may be configured to additionally select an agent based on a current agent queue, an estimated wait time, a history of interaction between the user and an agent, agent operating hours, and/or the like.

In some embodiments, the dialed number for the incoming call may correspond to an individual rather than a group, department, team, etc. In such an instance, the communication management circuitry 210 may determine whether the agent associated with the dialed number (e.g., verified internal phone number) is associated with an authenticated session. In an instance the agent is associated with an authenticated session, the communication management circuitry 210 may select this agent. Otherwise, the communication management circuitry 210 may determine a verified internal phone number, department, team, group, etc. associated with the requested agent and may select a different agent that is also associated with a corresponding verified internal phone number, department, team, group, etc. In some embodiments, the communications hardware 206 may provide a notification to the user device (e.g., user device 106A) that the requested agent is currently unavailable.

At operation 712, the apparatus 200 includes means, such as processor 202, memory 204, communications hardware 206, communication management circuitry 210, or the like for causing the user device to be connected to an agent device of the selected agent. Once the communication management circuitry 210 has selected an agent, the call from the user device (e.g., user device 106A) may be connected with an agent device of the selected agent. As such, the user may be connected to an agent that may aid the user with his/her needs. Additionally, the user need not navigate through the conventional call routing system, which may conserve network bandwidth and computational resources that would ordinarily be tasked with this conventional routing mechanism. Furthermore, as described in further detail in operations 714 and 716, the parties may be provided with an indication that the other party is authenticated such that bidirectional trust may be established for the call.

In some embodiments, an agent may be associated with multiple agent devices. In some embodiments, the communication management circuitry 210 may select an agent device associated with the agent to connect to the user device. In some embodiments, the communication management circuitry 210 may select an agent device based on the type of call. For example, in an instance in which the incoming call type is a cellular or landline call, the communication management circuitry 210 may select a landline agent device or cellular agent device as the agent device. As another example, in an instance in which the incoming call type is a VOIP call, the communication management circuitry 210 may select a desktop agent device, laptop agent device, and/or cellular phone agent device as the agent device. In some embodiments, an agent profile associated with the agent may be indicative of a preferred agent device. Thus, the communication management circuitry 210 may select an agent device based on the call type and/or agent preferences.

Once the communication management circuitry 210 has selected an agent device, the communication management circuitry 210 may cause the call from the user device (e.g., user device 106A) to be connected to the agent device (e.g., agent device 108A) over an associated communication channel. The communication channel may be dependent upon the incoming call type. In some embodiments, the communications hardware 206 may provide instructions to route the call to the particular agent device. For example, the communications hardware 206 may provide instructions to the call routing system to route the particular call to a verified internal phone number that corresponds to the selected agent. As such, this may cause a connection to be established between the user device (e.g., user device 106A) and the agent device (e.g., agent device 108A).

As described in operation 704, in some embodiments, the communication management circuitry 210 may have flagged the incoming call. This may be due to a lack of additional device identifiers other than the phone number of the associated user device. In such an instance, the communication management circuitry 210 may still connect the user and the agent but may require additional authentication protocols for the user. The additional authentication protocols may be necessary to confirm the identity of the user and ensure that the user device is not a spoofed device. In some embodiments, prior to connecting the user device (e.g., user device 106A), the one or more authentication protocols may require that the user provide one or more responses and/or inputs. By way of particular example, an authentication protocol may require the user to audibly respond or manually input (e.g., via a dial pad) a user response to one or more questions (e.g., a last four digits of a user's SSN, a user account PIN, security questions, a birthdate, or the like) on the call, such as via an IVR associated with the call routing system. In some embodiments, the call routing system may record the user responses and if needed, transform the captured responses such as by using a STT technique. The communication management circuitry 210 may then compare the user provided responses to the values stored in the user account. In an instance in which the communication management circuitry 210 determines that the user provided response correspond to the stored values, the communication management circuitry 210 may successfully authenticate the user. Otherwise, the user may remain unauthenticated and may be required to perform one or more authentication protocols as described in operation 716.

At operation 714, the apparatus 200 includes means, such as processor 202, memory 204, communications hardware 206, communication management circuitry 210, or the like for providing an indication to the user that the current call is with an authorized agent. Once the communication management circuitry 210 has caused the user device (e.g., user device 106A) and agent device (e.g., agent device 108A) to be connected, the communications hardware 206 may provide an indication that the call is with an authorized agent such that the user is made aware that the identity of the agent with whom they are speaking has been authenticated.

The communications hardware 206 may provide the indication in any suitable form. For example, the communications hardware 206 may provide instructions to the call routing system, the user device (e.g., user device 106A), and/or agent device (e.g., agent device 108A) to cause an audio recording to be played on the call between the user and the agent. The audio recording may convey that the user is speaking with an authorized agent. In some embodiments, the communications hardware 206 may provide a push notification, prompt, text message, email, and/or the like to the user device (e.g., user device 106A) that conveys that the agent with whom the user is currently speaking with is an authenticated agent. In some embodiments, an associated software application may display a visual confirmation and/or auditory recording alerting the user that the call is with an authorized agent.

At operation 716, the apparatus 200 includes means, such as processor 202, memory 204, communications hardware 206, authentication circuitry 208, communication management circuitry 210, or the like for providing an indication to the agent that the current call is with an authenticated user. Once the communication management circuitry 210 has caused the user device (e.g., user device 106A) and agent device (e.g., agent device 108A) to be connected, the communications hardware 206 may provide an indication that the call is with an authenticated user to the agent. As such, the agent that is handling the call may be provided with an indication that the identity of the user and/or user device (e.g., user device 106A) has been authenticated and the agent may proceed with handling the user's inquiries.

In some embodiments, the communications hardware 206 may provide the indication to the agent using the same agent device as the agent device (e.g., agent device 108A) that is connected with the user device (e.g., user device 106A). For example, for a call over VOIP, the agent device (e.g., agent device 108A) may be a desktop that is connected with the user device and also can receive and display the indication of that the call is with an authenticated user. Alternatively, the communications hardware 206 may provide the indication to the agent using a different agent device (e.g., agent device 108N) than the agent device (e.g., agent device 108A) that is connected with the user device (e.g., user device 106A). For example, for a call over a landline or cellular network, an agent device (e.g., agent device 108A) that is connected with the user device may be a landline connected phone and another agent device (e.g., agent device 108N) may be a desktop that may receive and display the indication of that the call is with an authenticated user. The communication management circuitry 210 may determine the agent device to provide the indication based on the call type and/or agent preferences and the communications hardware 206 may provide the indication to the agent device determined by the communication management circuitry 210.

In some embodiments, the communications hardware 206 may further provide user account information associated with the identifier user account to the agent. As such, the agent may view the user account information associated with the user to better facilitate user inquiries and/or requests. In some embodiments, the communications hardware 206 may provide the agent device with access to the user account such that the agent may make changes, cause actions to be performed, and/or the like for the user responsive to user requests made on the call.

As described in operation 704, in some embodiments, the communication management circuitry 210 may have flagged the incoming call. This may be due to a lack of additional device identifiers other than the phone number of the associated user device. In such an instance, the communication management circuitry 210 may still connect the user and the agent but may require additional authentication protocols for the user. In some embodiments, the additional authentication protocols may additionally or alternatively be performed during operation 712.

Prior to the communications hardware 206 providing the indication that the current call is with an authenticated user, the communication management circuitry 210 may determine one or more additional authentication protocols to be performed for the user. The additional authentication protocols may be necessary to confirm the identity of the user and ensure that the user device is not a spoofed device. For example, in some embodiments, the additional authentication protocol may require that the agent asks the user one or more questions (e.g., security questions, a birthdate, a residential address, an email address, or the like) and that the agent compare the provided user response to the stored user values in the user profile. The communication management circuitry 210 may determine whether the user is successfully authenticated based on agent feedback or an agent response. In an instance in which the communication management circuitry 210 receives confirmation that the agent has confirmed the user provided values correspond to the stored values, the communication management circuitry 210 may successfully authenticate the user and the communications hardware 206 may provide the indication that the current call is with the authenticated user to the agent, as described above.

As another example, the additional authentication protocol may additionally, or alternatively, require that the communications hardware 206 provide an OTP to the user device (e.g., user device 106A) or agent device (e.g., agent device 108A or agent device 108N) and require the other party to input the OTP into a software application or an internal account environment. By way of particular example, authentication circuitry 208 may be used to generate an OTP. The communications hardware 206 may provide this OTP to the user device (e.g., user device 106A) or to the user using a particular communication channel (e.g., email, text message, push notification). The user may be required to enter the OTP within a secure session associated with the user within an associated software application. Alternatively, the user may be required to provide the OTP (e.g., audibly over the call) to the agent. The agent may then enter the provided OTP into the secure account environment. The authentication circuitry 208 may then compare the received OTP as received from either the user or agent and determine whether the input OTP matches the sent OTP. In an instance in which the authentication circuitry 208 determines that the OTPs match, the communication management circuitry 210 may successfully authenticate the user and the communications hardware 206 may provide the indication that the current call is with the authenticated user to the agent, as described above.

It will be appreciated that other authentication protocols may be contemplated in addition to the above-described protocols. In an instance in which the user and/or user devices fails an authentication protocol, the communication management circuitry 210 may provide an indication that the current call is with a user that could not be authenticated. In some embodiments, the communication management circuitry 210 may allow the user to reattempt one or more of the authentication protocols before determining the user could not be authenticated. If the user cannot be authenticated, the agent may refrain from taking further action with respect to the user account, thus protecting the security of the user account.

At operation 718, the apparatus 200 includes means, such as processor 202, memory 204, communications hardware 206, authentication circuitry 208, communication management circuitry 210, blockchain management circuitry 212, or the like for updating a call history record. In some embodiments, a call history record may be updated to reflect the incoming call. In some embodiments, updating the call history record may include generating and updating a call history database, a DID document associated with a user DID, and/or a DID document associated with an agent DID to reflect the call. In doing so, the incoming call may be recorded and can be referenced at a later time if needed.

In some embodiments, the call history database may include a call history log for all calls received by a call routing system and/or routed to a verified internal phone number. As such, the incoming call received in operation 702 may be reflected in the call history log and the communication management circuitry 210 may update the entry to reflect whether the DID document associated with the user DID was indicative of a call request, whether the user was successfully authenticated, whether the agent was successfully authenticated, and call details (e.g., a user identifier of the user, an agent identifier of the agent, the type of call, a call duration, actions taken on the call, or the like).

Additionally, or alternatively, in some embodiments, the blockchain management circuitry 212 may update a call history record by updating a DID document for the user DID to reflect the call. As described above, the user account may include a user DID that may represent a unique, digital identity for the user. The blockchain management circuitry 212 may use a DID resolver with the DID method to query the DID storage repository 112 and the query may retrieve the latest transaction related to the user DID, including the hash and/or reference to a corresponding DID document. The blockchain management circuitry 212 may then access the DID document and update an associated call history log within the DID document corresponding to the user. For example, the blockchain management circuitry 212 may update a call history log to reflect whether the DID document was indicative of a call request, whether the user was successfully authenticated, whether the agent was successfully authenticated, and call details (e.g., a user identifier of the user, an agent identifier of the agent, the type of call, a call duration, actions taken on the call, or the like). Additionally, the blockchain management circuitry 212 may update a call request status for a corresponding call request in the call request log.

Once the DID document has been updated, the blockchain management circuitry 212 may be configured to digitally sign the updated DID document using a private cryptographic key associated with a public cryptographic key included in the DID document. The blockchain management circuitry 212 may then determine the hash of the updated DID document and submit a new transaction that includes the user DID, the digital signature signed using the private cryptographic key, and the updated hash of the DID document along with any desired additional metadata (e.g., a reference to the storage location of the DID document) to the DID storage repository 112. The blockchain network (e.g., DID storage repository 112) may verify the transaction using the public cryptographic key from the DID document. If the digital signature is valid, the blockchain network may record the updated information in user DID. As such, the user DID within the DID storage repository 112 may be configured with the transaction history of all changes or updates made to the DID document.

Additionally, or alternatively, in some embodiments, the blockchain management circuitry 212 may update a call history record by updating a DID document for an agent DID to reflect the call. In some embodiments, the agent account may include an agent DID that may represent a unique, digital identity for the agent. The blockchain management circuitry 212 may update the DID document associated with the agent DID in a substantially similar manner as described with respect to updating the DID document associated with the user DID. As such, the DID document associated with the agent DID may also be updated to reflect the call within the history of the agent.

At operation 720, the apparatus 200 includes means, such as processor 202, memory 204, communications hardware 206, communication management circuitry 210, or the like for determining agent information. In some embodiments, the communication management circuitry 210 may determine agent information for the agent with whom the user is connected with. In some embodiments, the communication management circuitry 210 may identify an agent profile within a direct inward dialing system and/or stored within another associated memory and use the agent profile to determine the agent information. For example, the agent profile may include the agent's name, email address, department, group, team, locality or region, expertise, working hours, workdays, an agent profile picture, or provided agent hobbies. The communication management circuitry 210 may be configured to select some or all of the information included in the agent profile as the agent information.

At operation 722, the apparatus 200 includes means, such as processor 202, memory 204, communications hardware 206, or the like for providing the agent information to the user device. Once the communication management circuitry 210 has determined the agent information, the communications hardware 206 may provide the agent information to the user device (e.g., user device 106A). In some embodiments, the communications hardware 206 may provide the agent information using an HTTP/HTTPS protocol and/or may use specific APIs, such as RESTful APIs or WebSocket APIs. This may cause the agent information to be displayed to the user within the software application executing on the user device (e.g., user device 106A) such that the user may be provided with additional assurance of the identity of the agent with whom they are speaking.

Turning now to FIG. 8, example operations are shown for generating a DID and corresponding DID document. As described above, a DID document for a user DID may be used for a variety of purposes, including to reflect call requests pertaining to the user and as an indication of whether an incoming call was previously requested by the user and may further serve to reflect a call history of the user. Similarly, a DID document for an agent DID may reflect a call history of the agent. In some embodiments, apparatus 200 may handle DID creation requests for a user DID and/or agent DID and the associated DID documents for the above-described uses.

As shown by operation 802, the apparatus 200 includes means, such as processor 202, memory 204, communications hardware 206, or the like for identify a DID creation request. In some embodiments, the DID creation request may be indicative of a request for a DID and corresponding DID document for a particular requestor (e.g., a user or an agent). The DID creation request may include a user identifier (e.g., a username, email, customer number, and/or the like) for a corresponding user or an agent identifier (e.g., a username, email, employee number, and/or the like) for a corresponding agent. As such, the DID creation request may identify the requestor (e.g., the user or the agent) for whom a DID is needed.

In some embodiments, the communications hardware 206 may receive a DID creation request from a corresponding user device (e.g., user device 106A) associated with the user or an agent device (e.g., agent device 108A) associated with the agent. Alternatively, the communications hardware may receive a notification, alert, or the like that a new user account or agent account has been opened and this new account alert and may identify a DID creation request based on this notification.

As shown by operation 804, the apparatus 200 includes means, such as processor 202, memory 204, blockchain management circuitry 212, or the like for generating a DID for the requestor. Responsive to identifying the DID creation request, the blockchain management circuitry 212 may generate a DID for requestor. A DID (e.g., a user DID, or an agent DID) may be representative of a globally unique, digital identity for the requestor (e.g., user or agent). Once a DID has been generated, the DID document may also reflect the corresponding DID.

To generate a DID, the blockchain management circuitry 212 may first select a DID method. A DID method may be indicative of how a DID is resolved and/or managed on the DID storage repository 112. In some embodiments, the DID method may be selected based on a type of blockchain embodied by the DID storage repository 112. In some embodiments, the DID method may be dependent upon whether the requestor is an agent or a user. The blockchain management circuitry 212 may be configured with a set of rules that may define the particular method to select for a DID based on the type of blockchain, the type of requestor (e.g., user or agent), and/or the like.

The blockchain management circuitry 212 may also generate an asymmetric cryptographic key pair that includes a private cryptographic key and a public cryptographic key. The blockchain management circuitry 212 may use any suitable technique to generate the asymmetric cryptographic key pair, such as by using an Rivest-Shamir-Adelman (RSA) technique, elliptic curve cryptography (ECC) technique, a Diffie-Hellman (DH) key exchange technique, a digital signature algorithm (DSA), and/or the like. In some embodiments, the blockchain management circuitry 212 may store the private cryptographic key in a secure location, such as in memory 204 or a within a cryptographic key management system. The private cryptographic key may be stored in an encrypted format and further, may be associated with the particular requestor, DID, or DID document. As such, the blockchain management circuitry 212 may access and use the corresponding private cryptographic key as needed, such to digitally sign a new transaction for an updated DID document, as described in operation 418 of FIG. 4.

In some embodiments, the blockchain management circuitry 212 may then generate the DID based on the public cryptographic key. By way of particular example, the blockchain management circuitry 212 may convert the public cryptographic key to bytes and encode the public cryptographic key to generate a string for the DID method. The blockchain management circuitry 212 may generate this string using any suitable technique.

The blockchain management circuitry 212 may then combine the selected DID method and string to generate the DID for the requestor. For example, the blockchain management circuitry 212 may select a DID method of “example” and generate a string of “123456abcdef.” The blockchain management circuitry 212 may then generate a DID of “did:example:123456abcdef” for the requestor.

In some embodiments the blockchain management circuitry 212 may provide the user DID to be stored in the associated account of the requestor (e.g., within a user account or an agent account). As such, the account of the requestor may include the corresponding DID such that the requestor and a corresponding DID document may linked through the DID.

As shown by operation 806, the apparatus 200 includes means, such as processor 202, memory 204, blockchain management circuitry 212, or the like for generating a DID document for the requestor. As described above, the DID document may be a JSON-LD file. The DID document may include industry-standard elements including a corresponding DID, a set of public cryptographic keys, a set of authentication methods to be used for authentication and a set of service endpoints. In some embodiments, the DID document may further include a call history record list that is configured to store the call history pertaining to the requestor. Additionally, in an instance in which the requestor is a user, the DID document may further include a call request log that may reflect information pertaining to call requests received from the user device (e.g., user device 106A) associated with the user. The call request log may allow for pertinent call request details for each received call request entry. This may include call context information, call request metadata, a determined call request reason, a requested agent indicated in the call request, a provided verified internal phone number, and/or the like.

In some embodiments, the blockchain management circuitry 212 may be configured with a standard template for a user and/or a standard template for an agent that it may use when generating the DID document. The standard template may define the elements for the DID document and the blockchain management circuitry 212 may populate particular values for fields within each element. For example, the blockchain management circuitry 212 may define an authentication method element within the DID document and may populate this element with a set of authentication methods to be used for a DID document from the standard template. As another example, the blockchain management circuitry 212 may define the public cryptographic key element and may populate the value of this element with public cryptographic keys that have been specifically generated for the DID and/or DID document.

As shown by operation 808, the apparatus 200 includes means, such as processor 202, memory 204, communications hardware 206, blockchain management circuitry 212, or the like for storing the DID document. As described above, the DID document may be stored within an associated storage system, such as communications storage repository 114. In some embodiments, the communications storage repository 114 may be an IPFS or a decentralized file system. Alternatively, the communications storage repository 114 may be a blockchain or a distributed database. In some embodiments, the communications hardware 206 may automatically upload the DID document to the communications storage repository 114 and further, may obtain a hash of the DID document. The blockchain management circuitry 212 may receive the hash of the DID document and/or a storage location that can be used to register the DID, as described in operation 810.

As shown by operation 810, the apparatus 200 includes means, such as processor 202, memory 204, blockchain management circuitry 212, or the like for registering the DID. Once the blockchain management circuitry 212 has generated the DID and DID document for the requestor, the blockchain management circuitry 212 may register the DID on the DID storage repository 112. In some embodiments, the blockchain management circuitry 212 may submit a transaction that includes the DID for the requestor, a digital signature signed using the private cryptographic key, and the hash of the DID document along with any desired additional metadata (e.g., a reference to the storage location of the DID document) to the DID storage repository 112. The DID storage repository 112 may provide confirmation of the registration to the blockchain management circuitry 212. Once the DID is registered on the DID storage repository 112, it may serve as an immutable and trusted means for determining user call requests and/or call history for the requestor (e.g., a user or an agent).

### Example Client-Side Operations

Example flowcharts are illustrated that contain example operations implemented by example embodiments described herein. The operations illustrated in FIGS. 9-10 may, for example, be performed by a user device (e.g., any one of user devices 106A-106N) and/or an agent device (e.g., any one of agent devices 108A-108N) shown in FIG. 1, which may in turn be embodied by an apparatus 300, which is shown and described in connection with FIG. 3. To perform the operations described below, the apparatus 300 may utilize one or more of processor 302, memory 304, communications hardware 306, interface circuitry 308, authentication circuitry 310, and/or any combination thereof.

Turning now to FIG. 9, example operations are shown for establishing a secure session or an authenticated session with the identity authentication management system 102. The operations described in FIG. 9 may be performed by either a user using a user device (e.g., user device 106A) or an agent device (e.g., agent device 108A) to establish a secure session or an authenticated session, respectively.

As shown by operation 902, the apparatus 300 includes means such as processor 302, memory 304, communications hardware 306, interface circuitry 308, or the like for providing a logon request. In some embodiments, apparatus 300 may be executing an associated software application associated with the identity authentication management system 102 and the interface circuitry 308 may receive feedback from a requestor (e.g., an agent or a user) indicative of a request to log into an associated account (e.g., a user account or agent account). In some embodiments, the interface circuitry 308 may receive a request indicative to be authenticated using a passkey. In response, the processor 302 may generate the logon request that includes a user identifier (e.g., a username, email, customer number, and/or the like), which may be supplied by the user or from memory 204, and user credentials that may be indicative to be authenticated using a device passkey. The processor may further include a device identifier for the user device. The communications hardware 306 may then provide the logon request to the identity authentication management system 102. In some embodiments, the logon request may be provided using a HTTP or HTTPS protocol (e.g., an HTTP/HTTPS request).

As shown by operation 904, the apparatus 300 includes means such as processor 302, memory 304, communications hardware 306, or the like for receiving a challenge. In an instance in which the logon request was indicative of a request to be authenticated using a passkey, the communications hardware 306 may receive a challenge from the identity authentication management system 102.

As shown by operation 906, the apparatus 300 includes means such as processor 302, memory 304, authentication circuitry 310, or the like for digitally signing the challenge. The authentication circuitry 310 may be configured to store a private cryptographic key for a corresponding passkey and may use this private cryptographic key to digitally sign the provided challenge. In some embodiments, the private cryptographic key may be stored in an encrypted manner and may require the authentication circuitry 310 to decrypt it before it can be used to digitally sign the challenge.

As shown by operation 908, the apparatus 300 includes means such as processor 302, memory 304, communications hardware 306, or the like for providing the digitally signed challenge. Once the authentication circuitry 310 has digitally signed the challenge using the private cryptographic key, the communications hardware 306 may provide the digitally signed challenge to the identity authentication management system 102. In some embodiments, the digitally signed challenge is provided in challenge response. The digitally signed challenge and/or challenge response may be provided using an HTTP/HTTPS protocol (e.g., an HTTP/HTTPS response).

As shown by operation 910, the apparatus 300 includes means such as processor 302, memory 304, communications hardware 306, or the like for receiving a notification of whether the authentication of the logon request was successful. As described in operations 404 and 406 of FIG. 4, the identity authentication management system 102 may perform an authentication routine to determine whether the logon request was successfully authenticated.

In an instance in which the logon request failed to be authenticated, the notification may be a logon error notification as described in operation 912. As shown by operation 912, the apparatus 300 includes means such as processor 302, memory 304, communications hardware 306, or the like for receiving a logon error notification. The logon error notification may be indicative that the logon request failed to be successfully authenticated. In some embodiments, the logon request may be indicative of the reason for the authentication failure. For example, in an instance in which the authentication routine used a passkey but failed to verify the digitally signed challenge, the logon error notification may be indicative that the authentication using a passkey has failed. In some embodiments, the logon error notification may include instructions for a requestor to retry or resubmit the logon request using different user credentials (e.g., a password, biometric data, PIN, and/or the like).

In an instance in which the logon request was successfully authenticated, the notification may be an indication that the logon request was successful, and a secure session or authenticated session may be established as described in operation 914. As shown by operation 914, the apparatus 300 includes means such as processor 302, memory 304, communications hardware 306, or the like for establishing a secure session or authenticated session with the identity authentication management system 102. In some embodiments, if the requestor is the user, the communications hardware 306 may receive a response (e.g., an HTTP/HTTPS response) that includes user account data for the user account. In some embodiments, if the requestor is the agent, the communications hardware 306 may receive a response (e.g., an HTTP/HTTPS response) that includes agent account data for the agent account. In some embodiment, the communications hardware 306 may use specific APIs, such as RESTful APIs or WebSocket APIs to receive the user account data or agent account data.

Turning now to FIG. 10, example operations are shown for performing a call operation. The operations described in FIG. 10 may be performed by a user using a user device (e.g., user device 106A).

As shown by operation 1002, the apparatus 300 includes means such as processor 302, memory 304, interface circuitry 308, or the like for presenting the received data to the user. Once a secure session has been established with the identity authentication management system 102, the interface circuitry 308 may cause presentation of the received data to the user. The received data may include user account data such that the user may view their current user account data and/or information and additionally, may perform one or more actions with respect to the user account. The received data may be presented within the software application associated with the identity authentication management system 102.

In some embodiments, the presented data may include one or more interaction elements, include a call request interaction element. A call request interaction element may be any element (e.g., button, link, icon, or the like) that a user may interact with (e.g., select, click, audibly chose, or the like) to convey the user's desire for a call with an agent of the identity authentication management system 102. In some embodiments, there interface circuitry 308 may be configured to display one or more call request interaction elements that may each convey additional information about the call request, such as a call request reason.

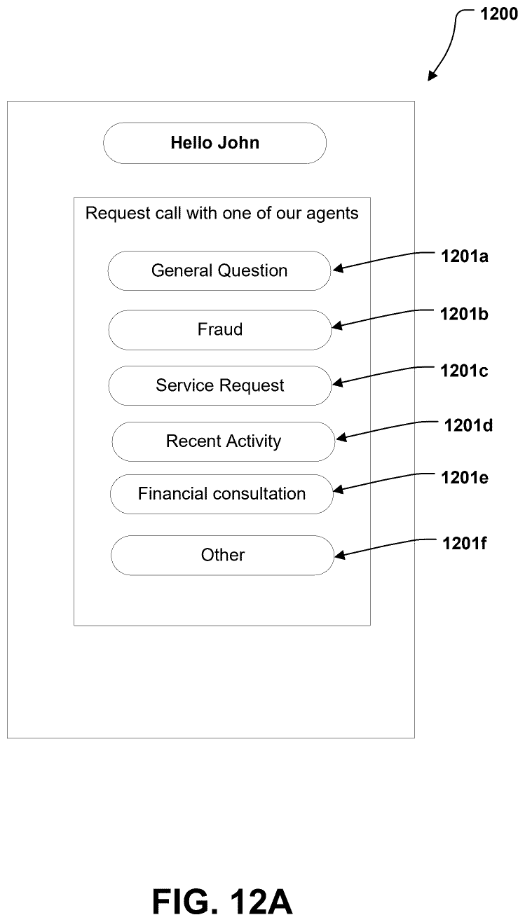

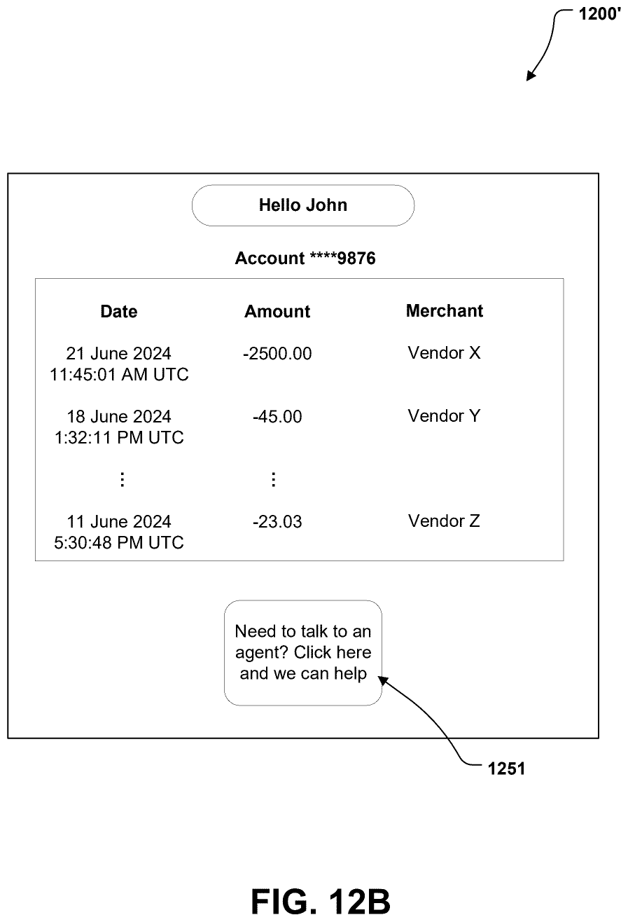

Turning to FIGS. 12A-12B, GUIs are provided that illustrates example call request interaction elements. The GUIs shown in FIGS. 12A-12B may be displayed to the user by the interface circuitry 308. As shown in FIG. 12A, the GUI 1200 may include multiple call request interaction elements 1201a, 1201b, 1201c, 1201d, 1201e, and 1201f. Each call request interaction element may provide additional information about the call request reason.

Additionally, or alternatively, as shown in FIG. 12B, the GUI 1200′ may include a single call request interaction element 1251 that may be displayed in a software application page. As shown in GUI 1200′, the user may interact with the call request interaction element 1251 while on a particular software application page, such as the transaction history page shown.

As shown by operation 1004, the apparatus 300 includes means such as processor 302, memory 304, communications hardware 306, interface circuitry 308, or the like for receiving user input indicative of a call request. In some embodiments, the communications hardware 306 may receive feedback from the user indicative of a call request. In particular, the user may interact with a call request interaction element as described above and the communications hardware 306 may receive this input and determine it is indicative of a call request.

As shown by operation 1006, the apparatus 300 includes means such as processor 302, memory 304, communications hardware 306, or the like for providing the call request. Responsive to receiving input indicative of a call request, the communications hardware 306 may provide a call request to the identity authentication management system 102. In some embodiments, the communications hardware 306 may further include call context information and/or call request metadata with the call request. In some embodiments, the call request may further be indicative of a preferred communication channel (e.g., over a PSTN, cellular network, VoIP network, or the like). In some embodiments, the call request may be provided using a HTTP/HTTPS protocol (e.g., an HTTP/HTTPS request).

As shown by operation 1008, the apparatus 300 includes means such as processor 302, memory 304, communications hardware 306, or the like for receiving a verified internal phone number. The communications hardware 306 may receive a verified internal phone number from the identity authentication management system 102 in response to the provided call request. The verified internal phone number may correspond to a phone number provided by identity authentication management system 102 that may be establish a connection with an agent. The interface circuitry 308 may cause presentation of a verified internal phone number interaction element that the user may interact with.

As shown by operation 1010, the apparatus 300 includes means such as processor 302, memory 304, communications hardware 306, interface circuitry 308, or the like for receiving user input for a verified internal phone number interaction element. As described above, the interface circuitry 308 may cause presentation of a verified internal phone number interaction element and the communications hardware 306 may receive user input corresponding to the verified internal phone number interaction element. This may be indicative that the user wishes to perform a call using the provided verified internal phone number. In some embodiments, the communications hardware 306 may further receive user input indicative of the type of call and/or which communication channel should be used to perform the call.

As shown by operation 1012, the apparatus 300 includes means such as processor 302, memory 304, communications hardware 306, interface circuitry 308, or the like for performing the call operation using the verified internal phone number. The communications hardware 306 may then perform the call operation based on the provided user input. In some embodiments, the communications hardware 306 may cause the verified internal phone number to be provided to an associated dialer application and the dialer application may be used to perform the call (e.g., over a cellular network or PSTN). Alternatively, the communications hardware 306 may cause the software application to perform an audio call using the verified internal phone number (e.g., over a VoIP network). The communications hardware 306 may select the mechanism to perform the call based on user input and/or settings configured on the apparatus.

The call may be routed to an agent and in some embodiments, the communications hardware 306 may receive agent information and/or an indication that the current call is with an authenticated agent. In some embodiments, the interface circuitry 308 may be configured to display a visual notification that the call is with an authenticated agent or cause an audio message conveying that the call is with an authenticated agent to be played. Additionally, the interface circuitry 308 may cause presentation the agent information such that the user may view the agent information and confirmation that the call is with the authenticated agent.

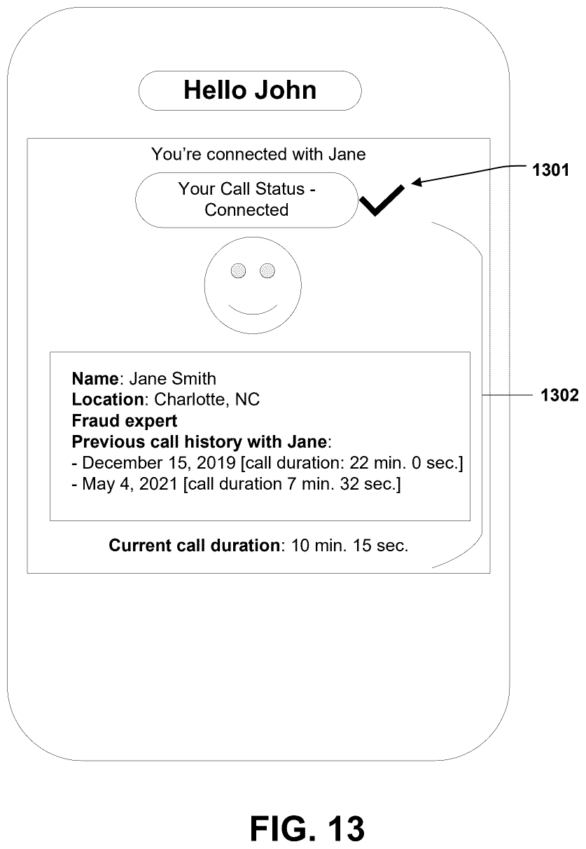

Turning to FIG. 13, a GUI is provided that illustrates displayed agent information and an indication that the call is with an authenticated agent. In particular, the GUI includes a notification 1301 that conveys that the current call is connected and provides visual indicia (e.g., a checkmark) indicative that the agent has been authenticated. Additionally, the GUI includes agent information 1302 that provides the user with additional information about the agent.

FIGS. 4-10 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices that perform the specified functions, or combinations of special purpose hardware and software instructions.

### Example System Interaction

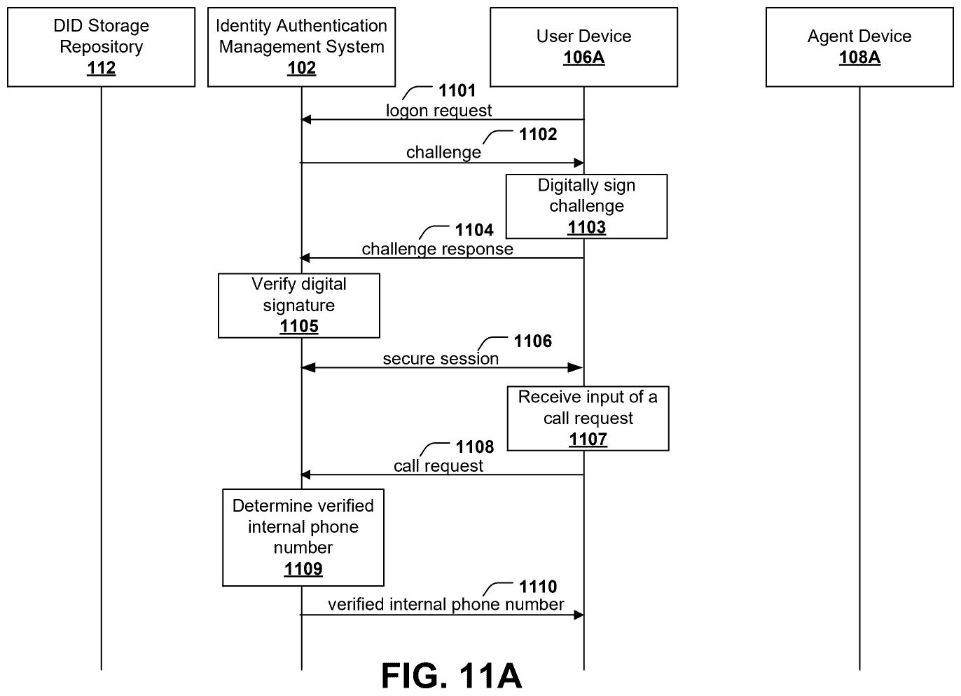

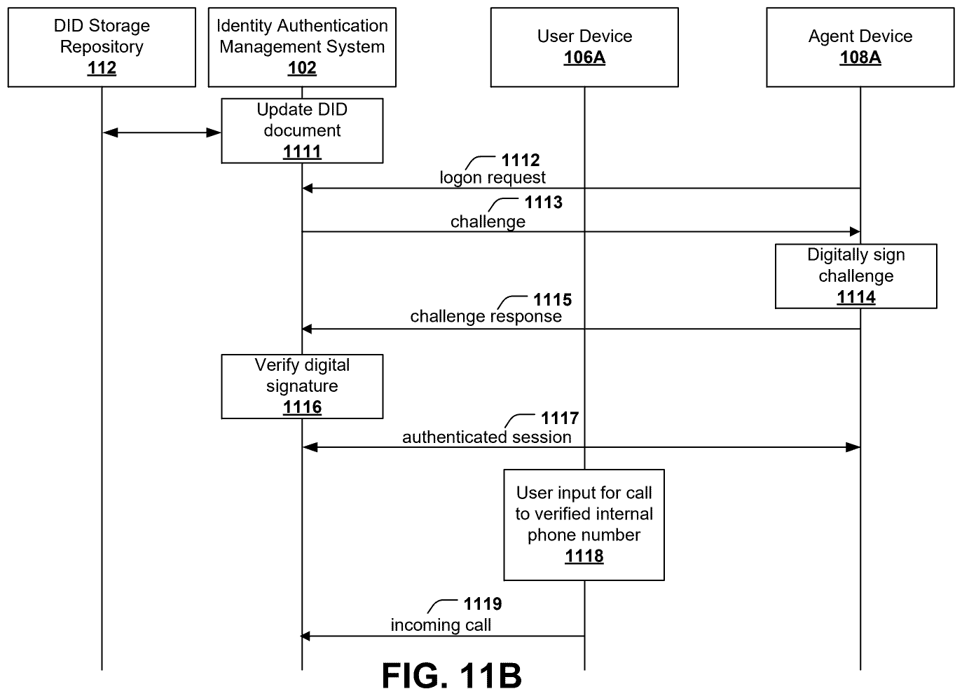

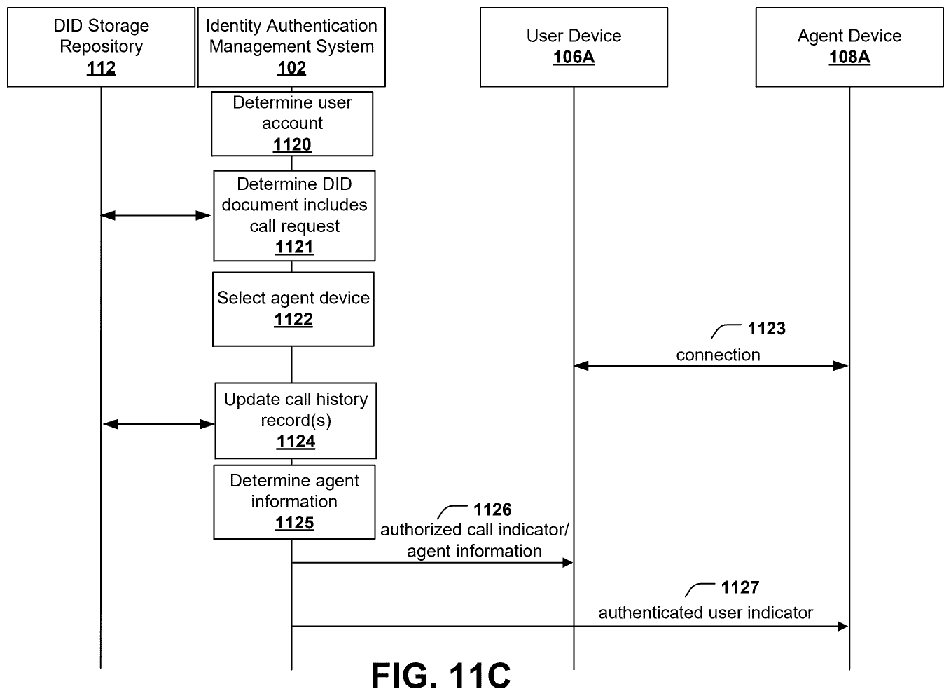

FIGS. 11A, 11B and 11C show swim lane diagrams illustrating example operations (e.g., as described above in connection with FIGS. 4-10) performed by components of the environment depicted in FIG. 1 to produce various benefits of the implementations described herein. The operations shown in the swim lane diagram performed by a user device are shown along the line extending from the box labeled “user device 106A”, operations performed by an identity authentication management system are shown along the line extending from the box labeled “identity authentication management system 102”, operations performed by an agent device are shown along the line extending from the box labeled “agent device 108A”, and operations performed by the DID storage repository are shown along the line extending from the box labeled “DID storage repository 112”. Operations impacting multiple devices, such as data transmissions between the devices, are shown using arrows extending between these lines. Generally, these operations are ordered temporally with respect to one another. However, it will be appreciated that the operations may be performed in other orders from those illustrated in FIGS. 11A-11C.

At operation 1101, the user device 106A may provide a logon request to the identity authentication management system 102. At operation 1102, the identity authentication management system 102 may provide a challenge to the user device 106A as part of an authentication routine. At operation 1103, the user device 106A may digitally sign the challenge. At operation 1104, the user device 106A may provide the challenge response to the identity authentication management system 102. At operation 1105, the identity authentication management system 102 may verify the digital signature to determine whether to authenticate the logon request. At operation 1106, in an instance in which the identity authentication management system 102 successfully authenticates the logon request, the identity authentication management system 102 may establish a secure session with the user device 106A. At operation 1107, the user device 106A may receive input indicative of a call request. At operation 1108, the user device 106A may provide the call request to the identity authentication management system 102. At operation 1109, the identity authentication management system 102 may determine a verified internal phone number for the call request. At operation 1110, the identity authentication management system 102 may provide the verified internal phone number to the user device 106A.

Turning now to FIG. 11B, at operation 1111, the identity authentication management system 102 may update a DID document associated with the user. The identity authentication management system 102 may use a user DID stored in the DID storage repository 112 to identify the location of the DID document and may provide an updated transaction for the user DID to the communications storage repository containing the hash of the updated DID document. At operation 1112, the agent device 108A may provide a logon request to the identity authentication management system 102. At operation 1113, the identity authentication management system 102 may provide a challenge to the agent device 108A as part of an authentication routine. At operation 1114, the agent device 108A may digitally sign the challenge. At operation 1115, the agent device 108A may provide the challenge response to the identity authentication management system 102. At operation 1116, the identity authentication management system 102 may verify the digital signature to determine whether to authenticate the logon request. At operation 1117, in an instance in which the identity authentication management system 102 successfully authenticates the logon request, the identity authentication management system 102 may establish an authenticated session with the agent device 108A. At operation 1118, the user device 106A may receive user input indicative to place a call to the verified internal phone number. At operation 1119, the identity authentication management system 102 may receive an incoming call from the user device 106A.

Turning now to FIG. 11C, at operation 1120 the identity authentication management system 102 may determine a user account associated with the incoming call. At operation 1121, the identity authentication management system 102 may determine whether the DID document corresponding to the user is indicative of the call request. The identity authentication management system 102 may use the user DID stored in the DID storage repository 112 to access the DID document corresponding to the user DID. At operation 1122, the identity authentication management system 102 may select an agent device. At operation 1123, the identity authentication management system 102 may cause the user device 106A and agent device 108A to be connected. At operation 1124, the identity authentication management system 102 may update call history records. At operation 1125, the identity authentication management system 102 may determine agent information. At operation 1126, the identity authentication management system 102 may provide an indication that the agent is an authorized agent and/or agent information to the user device. At operation 1127, the identity authentication management system 102 may provide an indication that the user is an authenticated user to the agent device 108A.

### CONCLUSION

As described above, example embodiments provide methods and apparatuses that enable improved call authentication that allows for bidirectional trust to be established between a user and an agent. Example embodiments thus provide tools that overcome the problems faced by conventional call routing system, which fail to provide assurances to users that they are speaking with authorized representatives. Additionally, example embodiments also provide a streamlined mechanism for authentication of the user by leveraging secure sessions between an identity authentication management system and the user device, which may serve to pre-stage the incoming call from the user device. Furthermore, example embodiments described herein leverage the secure immutable nature of distributed ledgers and blockchains to ensure that call requests provided by a user device are legitimate.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for handling a call request, the method comprising:
receiving, by communications hardware, a logon request for a user account from a user device;
performing, by authentication circuitry, an authentication routine to determine whether to authenticate the logon request;
in an instance in which the logon request is successfully authenticated, establishing, by the communications hardware, a secure session with the user device;
receiving, by the communications hardware, the call request from the user device;
in response to receiving the call request, determining, by communication management circuitry, a verified internal phone number based on the call request;
providing, by the communications hardware, the verified internal phone number to the user device; and
updating, by the communication management circuitry, a decentralized identifier (DID) document associated with a user DID to reflect the call request.

2. The method of claim 1, further comprising:
receiving, by the communications hardware, a notification of an incoming call from the user device comprising a device identifier of the user device;
identifying, by the communication management circuitry, the user account associated with the device identifier, wherein the user account comprises the user DID;
determining, by the communication management circuitry, whether the DID document associated with the user DID comprises the call request;
in response to determining the DID document comprises the call request, selecting, by the communication management circuitry, an agent currently associated with an authenticated session; and
causing, by the communication management circuitry, the user device to be connected to an agent device of the selected agent.

3. The method of claim 2, further comprising;
determining, by the communication management circuitry, agent information associated with the selected agent; and
providing, by the communications hardware, the agent information to the user device.

4. The method of claim 2, further comprising providing, by the communications hardware, an indication that a current call is with an authorized agent.

5. The method of claim 2, further comprising updating, by the communication management circuitry, at least one of (a) a DID document associated with an agent DID, (b) the DID document associated with the user DID, or (c) a call history database, to reflect the incoming call from the user device.

6. The method of claim 1, wherein performing the authentication routine comprises:
generating, by the authentication circuitry, a challenge;
providing, by the communications hardware, the challenge to the user device;
receiving, by the communications hardware, a challenge response comprising a digital signature from the user device; and
verifying, by the authentication circuitry, the digital signature using a public cryptographic key of a passkey for the user account, wherein (i) the logon request is successfully authenticated in an instance in which the digital signature is successfully verified or (ii) the logon request fails to be authenticated in an instance in which the digital signature is not successfully verified.

7. The method of claim 1, further comprising:
receiving, by the communications hardware, a second logon request for an agent account from an agent device;
performing, by the authentication circuitry, the authentication routine to determine whether to authenticate the logon request based on a digital signature provided by the agent device; and
in an instance in which the second logon request is successfully authenticated, establishing, by the communications hardware, an authenticated session with the agent device.

8. An apparatus for handling a call request, the apparatus comprising:
communications hardware configured to receive a logon request for a user account from a user device;
authentication circuitry configured to perform an authentication routine to determine whether to authenticate the logon request,
wherein the communications hardware is further configured to:
in an instance in which the logon request is successfully authenticated, establish a secure session with the user device, and
receive the call request from the user device; and
communication management circuitry configured to, in response to receiving the call request, determine a verified internal phone number based on the call request,
wherein the communications hardware is further configured to provide the verified internal phone number to the user device,
wherein the communication management circuitry is further configured to update a decentralized identifier (DID) document associated with a user DID to reflect the call request.

9. The apparatus of claim 8, wherein the communications hardware is further configured to receive a notification of an incoming call from the user device comprising a device identifier of the user device;
wherein the communication management circuitry is further configured to:
identify the user account associated with the device identifier, wherein the user account comprises the user DID,
determine whether the DID document associated with the user DID comprises the call request,
in response to determining the DID document comprises the call request, select an agent currently associated with an authenticated session, and
cause the user device to be connected to an agent device of the selected agent.

10. The apparatus of claim 9, wherein the communication management circuitry is further configured to determine agent information associated with the selected agent,
wherein the communications hardware is further configured to provide the agent information to the user device.

11. The apparatus of claim 9, wherein the communications hardware is further configured to provide an indication that a current call is with an authorized agent.

12. The apparatus of claim 9, wherein the communication management circuitry is further configured to update at least one of (a) a DID document associated with an agent DID, (b) the DID document associated with the user DID, or (c) a call history database, to reflect the incoming call from the user device.

13. The apparatus of claim 8, wherein the authentication circuitry is further configured to generate a challenge,
wherein the communications hardware is further configured to:
provide the challenge to the user device, and
receive a challenge response comprising a digital signature from the user device,
wherein the authentication circuitry is further configured to verify the digital signature using a public cryptographic key of a passkey for the user account, wherein (i) the logon request is successfully authenticated in an instance in which the digital signature is successfully verified or (ii) the logon request fails to be authenticated in an instance in which the digital signature is not successfully verified.

14. The apparatus of claim 8, wherein the communications hardware is further configured to receive a second logon request for an agent account from an agent device,
wherein the authentication circuitry is further configured to perform the authentication routine to determine whether to authenticate the logon request based on a digital signature provided by the agent device,
wherein the communications hardware is further configured to, in an instance in which the second logon request is successfully authenticated, establish an authenticated session with the agent device.

15. A computer program product for handling a call request, the computer program product comprising at least one non-transitory computer-readable storage medium storing software instructions that, when executed, cause an apparatus to:
receive a logon request for a user account from a user device;
perform an authentication routine to determine whether to authenticate the logon request;
in an instance in which the logon request is successfully authenticated, establish a secure session with the user device;
receiving the call request from the user device;
in response to receiving the call request, determine a verified internal phone number based on the call request;
provide the verified internal phone number to the user device; and
update a decentralized identifier (DID) document associated with a user DID to reflect the call request.

16. The computer program product of claim 15, wherein the software instructions, when executed, further cause the apparatus to:
receive a notification of an incoming call from the user device, wherein the user device is associated with a device identifier;
identify the user account is associated with the device identifier;
determine whether the DID document associated with the user DID comprises the call request;
in response to determining the DID document is comprises the call request, select an agent currently associated with an authenticated session; and
cause the user device to be connected to an agent device of the selected agent.

17. The computer program product of claim 16, wherein the software instructions, when executed, further cause the apparatus to:
determine agent information associated with the selected agent; and
provide the agent information to the user device.

18. The computer program product of claim 16, wherein the software instructions, when executed, further cause the apparatus to provide an indication that a current call is with an authorized agent.

19. The computer program product of claim 16, wherein the software instructions, when executed, further cause the apparatus to update at least one of (a) a DID document associated with an agent DID, (b) the DID document associated with the user DID, or (c) a call history database, to reflect the incoming call from the user device.

20. The computer program product of claim 15, wherein the software instructions, when executed, further cause the apparatus to:
generate a challenge;
provide the challenge to the user device;
receive a challenge response comprising a digital signature from the user device; and
verify the digital signature using a public cryptographic key of a passkey for a user account, wherein (i) the logon request is successfully authenticated in an instance in which the digital signature is successfully verified or (ii) the logon request fails to be authenticated in an instance in which the digital signature is not successfully verified.
